(19) United States
(12) Patent Application Publication
(10) Pub. No.: US 2024/0242491 A1
(43) Pub. Date: Jul. 18, 2024

(54) APPARATUS, METHOD, AND STORAGE MEDIUM FOR IMPROVING RESULT OF INFERENCE BY LEARNING MODEL

(71) Applicant: CANON KABUSHIKI KAISHA, Tokyo (JP)

(72) Inventor: MASAFUMI TAKIMOTO, Kanagawa (JP)

(21) Appl. No.: 18/413,663

(22) Filed: Jan. 16, 2024

(30) Foreign Application Priority Data
Jan. 17, 2023 (JP) 2023-005394

(51) Int. Cl. G06V 10/778; G06V 10/75

(52) U.S. Cl. CPC G06V 10/778; G06V 10/759

(57) ABSTRACT

An apparatus includes at least one processor, and a memory coupled to the at least one processor, the memory storing instructions that, when executed by the at least one processor, cause the at least one processor to identify a partial image corresponding to an area in an image in which performance of inference by a learning model that performs predetermined inference on an input image is less than or equal to a threshold, collect a similar image similar to the identified partial image, and based on additional images including the collected similar image, improve a result of the inference by the learning model targeted at a test environment different from a training environment of the learning model.

### BACKGROUND

### Field of the Disclosure

The present disclosure relates to an apparatus, a method, and a storage medium.

### Description of the Related Art

In recent years, with the development of the machine learning and deep learning technologies, a wide variety of image recognition techniques and image generation techniques based on artificial intelligence (AI) (a trained model) have drawn attention. Examples of cases where AI is used in image generation techniques include image restoration for, if a degraded image is input, reducing the image quality degradation of the degraded image. Examples of degradation factors in the image include noise, defocus, low resolution, and a defect. The process of reducing the image degradation also covers a wide variety, such as noise removal, defocus removal, super-resolution, and defect complement.

The differences between degraded images and restored images are calculated using such an image degradation restoration mechanism, providing detection of images with greater differences as an abnormal image. Japanese Patent Application Laid-Open No. 2021-86382 discloses a technique for causing an autoencoder to learn normal images and obtaining in advance a network capable of stably restoring the pattern of the normal images, detecting an area that cannot be restored as an abnormal area.

Under a situation where the function regarding the detection of an abnormal image using the image degradation restoration mechanism exemplified above is applied, an event may occur where a normal area, unrelated to image degradation, is erroneously detected as an abnormal area when the extent of restoration of an image is low. In such a case, the performance of abnormality detection may be enhanced by performing additional learning on images of which the extent of restoration is low.

Even if a test environment and a learning environment are greatly different from each other, such a technique is expected to produce the effect of enhancing the performance of abnormality detection in the test environment by performing additional learning using images in the test environment and similar images.

### SUMMARY

According to an aspect of the present disclosure, an apparatus includes at least one processor, and a memory coupled to the at least one processor, the memory storing instructions that, when executed by the at least one processor, cause the at least one processor to identify a partial image corresponding to an area in an image in which performance of inference by a learning model that performs predetermined inference on an input image is less than or equal to a threshold, collect a similar image similar to the identified partial image, and based on additional images including the collected similar image, improve a result of the inference by the learning model targeted at a test environment different from a training environment of the learning model.

Further features of various embodiments will become apparent from the following description of exemplary embodiments with reference to the attached drawings.

### BRIEF DESCRIPTION OF THE DRAWINGS

FIG. 1 is a diagram illustrating an example of the configuration of an information processing system according to a first exemplary embodiment.

FIG. 2A is a functional block diagram illustrating an example of a functional configuration of the information processing system according to the first exemplary embodiment.

FIG. 2B is a functional block diagram illustrating an example of a functional configuration of an information processing system according to a second exemplary embodiment.

FIGS. 3A to 3C are diagrams illustrating an example of a method for obtaining a low-dimensional distance space according the first exemplary embodiment.

FIG. 4 is a flowchart illustrating an example of processing of the information processing system according to the first exemplary embodiment.

FIG. 5 is a diagram illustrating an example of processing regarding generation of degraded image data according to the first exemplary embodiment.

FIG. 6 is a diagram illustrating an example of processing regarding training of a model according to the first exemplary embodiment.

FIG. 7A is a flowchart illustrating an example of processing of the information processing system according to the first exemplary embodiment.

FIG. 7B is a flowchart illustrating an example of processing of the information processing system according to the first exemplary embodiment.

FIG. 8 is a flowchart illustrating an example of processing of the information processing system according to the first exemplary embodiment.

FIG. 9 is a functional block diagram illustrating an example of a functional configuration of the information processing system according to a third exemplary embodiment.

FIG. 10 is a flowchart illustrating an example of processing of the information processing system according to the third exemplary embodiment.

FIG. 11 is a functional block diagram illustrating an example of a functional configuration of an information processing system according to a fourth exemplary embodiment.

FIG. 12A is a flowchart illustrating an example of processing of the information processing system.

FIG. 12B is a flowchart illustrating an example of processing of the information processing system according to the fourth exemplary embodiment.

FIGS. 13A and 13B are diagrams illustrating an example of a case where person detection and tracking fail according to the fourth exemplary embodiment.

### DESCRIPTION OF THE EMBODIMENTS

Exemplary embodiments will be described below with reference to the drawings. The following exemplary embodiments do not limit every embodiment of the present disclosure, and not all the combinations of the features described in the present exemplary embodiments are used in a method for solving the issues in the present disclosure. The configurations of the exemplary embodiments can be appropriately modified or changed depending on the specifications of an apparatus to which the present disclosure is applied, or various conditions (the use conditions and the use environment). A configuration may be obtained by appropriately combining parts of the following exemplary embodiments. In the following exemplary embodiments, like numbers refer to like components in the description.

### <CNN>

First, a description is given of a convolutional neural network (CNN) used in exemplary embodiments described below and applied to general information processing techniques that use deep learning. The CNN is a technique for convolving a filter generated by training or learning with image data and then repeating a non-linear calculation. The filter is also referred to as a “local receptive field”. Two-dimensional data obtained by convolving the filter with the image data and performing the non-linear calculation is referred to as a “feature map”. The training or learning is performed using training data (training images or data sets) composed of a pair of input image data and output image data. To put it simply, the generation of the value of the filter capable of transforming input image data into corresponding output image data with high accuracy from the training data can be equivalent to the training or learning. The details will be described below.

When the image data has red, green, and blue (RGB) color channels, or when the feature map is composed of a plurality of pieces of image data, the filter used in the convolution also has a plurality of channels accordingly. That is, the convolution filter is represented by a four-dimensional array obtained by adding the number of channels in addition to the vertical and horizontal sizes and the number of images. The process of convolving the filter with the image data or the feature map and then performing the non-linear calculation is represented in units of layers, and for example, is represented as the feature map in the n-th layer or the filter in the n-th layer. For example, a CNN that repeats the convolution of the filter and the non-linear calculation three times has a three-layer network structure. Such a non-linear calculation process can be formulated as illustrated below in equation (1).

$$\begin{matrix}[ Math . 1 ] & \\ {X}_{n}^{( l )} = f ( {\sum }_{n = 1}^{N} {W}_{n}^{( l )} * {X}_{n - 1}^{( l )} + {b}_{n}^{( l )} ) & equation ( 1 )\end{matrix}$$

In equation (1), Wₙ represents the filter in the n-th layer, bₙ represents a bias in the n-th layer, f represents a non-linear operator, Xₙ represents the feature map in the n-th layer, and * represents a convolution operator. (l) represents an l-th filter or feature map. The filter (the weight) and the bias are generated by training described below. In the following description, the weight and the bias obtained by the training are also collectively referred to as a “model parameter”. As the non-linear calculation, for example, a sigmoid function or a rectified linear unit (ReLU) is used. The ReLU is given by the following equation (2). As illustrated in the following equation (2), among the elements of an input vector X, an element having a negative value is zero, and an element having a positive value has the value as it is.

$$\begin{matrix}[ Math . 2 ] & \\ f ( X ) = \{ \begin{matrix}X if 0 \leq X \\ 0 otherwise\end{matrix} & equation ( 2 )\end{matrix}$$

As networks using the CNN, for example, ResNet in the image recognition field and RED-Net as an application of ResNet in the super-resolution field are well-known. In either network, the CNN is multilayered, and the filter is convolved many times, providing high-accurate processing. For example, ResNet is characterized by a network structure where shortcut paths for convolution layers are provided. Based on this, ResNet achieves a multilayer network having 152 layers, achieving a high-accurate recognition close to the human recognition rate. The high accurate processing achieved by the multilayer CNN, to put it simply, is brought about by representation of the non-linear relationship between input and output through a lot of iterations of the non-linear calculation.

### <Training of CNN>

The training of the CNN will now be described. Generally, the training of the CNN is performed by minimizing an objective function represented by the following equation (3) with respect to training data composed of a set of input training image data and corresponding output training image (correct answer image) data.

$$\begin{matrix}[ Math . 3 ] & \\ L ( θ ) = \frac{1}{n} {\sum }_{1 = 1}^{n} {‖ F ( {X}_{i} ; θ ) - {Y}_{i} ‖}_{2}^{2} & equation ( 3 )\end{matrix}$$

In equation (3), L represents a loss function for measuring the error between a correct answer and the estimation of the correct answer. Yi represents i-th output training image data, and Xi represents i-th input training image data. F is a function collectively representing the calculation performed by each layer of the CNN (equation (1)). θ represents the model parameter (the filter and the bias). ∥Z∥₂ represents an L2 norm. To put it simply, ∥Z∥₂ is the square root of the sum of squares of the elements of a vector Z. n represents the total number of images of the training data used in the training.

Generally, since a total great number of images of training data is used, stochastic gradient descent (SGD) randomly selects a part of training image data and uses the selected part in training. This allows reduction of the calculation load in training using many pieces of training data. As a method for minimalizing (optimizing) the objective function, various methods, such as a momentum method, an AdaGrad method, an AdaDelta method, and an Adam method, are known. The Adam method is given by the following equation (4).

$$\begin{matrix}[ Math . 3 ] & \\ {θ}_{i}^{t + 1} = {θ}_{i}^{t} - α \frac{\sqrt{1 - {β}_{2}^{t}}}{( 1 - {β}_{1} )} \frac{m}{( \sqrt{v} + ε )} & equation ( 4 )\end{matrix}$$

$$v = {β}_{2} v + ( 1 - {β}_{2} ) {g}^{2}$$

$$m = {β}_{1} m + ( 1 - {β}_{1} ) g$$

$$g = \frac{\partial L}{\partial {θ}_{i}^{t}}$$

In equation (4), θᵢ^{t} represents the i-th model parameter in the t-th iteration, and g represents the gradient of the loss function L regarding θᵢ^{t}. m and v represent moment vectors, α represents the base learning rate, β₁ and β₂ represent hyperparameters, and ε represents a small constant. There is no guideline for selecting the optimization method in the training, and, basically, any method can be used. It is, however, known that a difference between convergences of methods differs causes a different training time.

In the present exemplary embodiment, information processing (image processing) for reducing the degradation of images is performed using the above CNN. Examples of degradation factors in images include noise, defocus, aberration, compression, low resolution, and defect, and contrast reduction under the influence of the weather, such as fog, haze, snow, or rain, when an image is captured. Examples of the image processing for reducing the degradation of images include noise removal, defocus removal, aberration correction, defect complement, the correction of degradation due to compression, a super-resolution process on a low-resolution image, and the process of correcting contrast reduction due to the weather when an image is captured.

The image degradation reduction process according to the present exemplary embodiment involves generating or restoring an image without degradation (or with a very little degradation) from an image with degradation, which is also referred to as an “image restoration process” in the following description. In other words, for example, the image restoration according to the present exemplary embodiment includes a case of allowing a reduction in degradation included in the original image itself, as well as in addition to a case of restoring an image that had no degradation (has a little degradation) which has degraded due to subsequent amplification, compression and decompression, or another type of image processing.

The image restoration process using a neural network can achieve image restoration performance exceeding the conventional process without the use of a neural network with respect to image degradation that can be represented by particular parameters. On the other hand, when a scene having a tendency different from that when training is performed is captured, the level of restoration of an image whose degradation level is equivalent may decrease.

To obtain a favorable result in a test environment having a tendency different from that when training is performed, normally, after a training data set composed of a pair of a degraded image obtained by giving a known image degradation pattern to a correct answer image obtained in the test environment and the correct answer image is created, additional learning is performed. Such additional learning provides an improved level of image restoration performance in the test environment.

In the test environment, however, it may be difficult to obtain a true correct answer image because only an already degraded image is obtained.

In a first exemplary embodiment of the present disclosure, an example will be described of a method for performing the process of reducing noise in input images using a neural network.

### (Example of Configuration of Information Processing System)

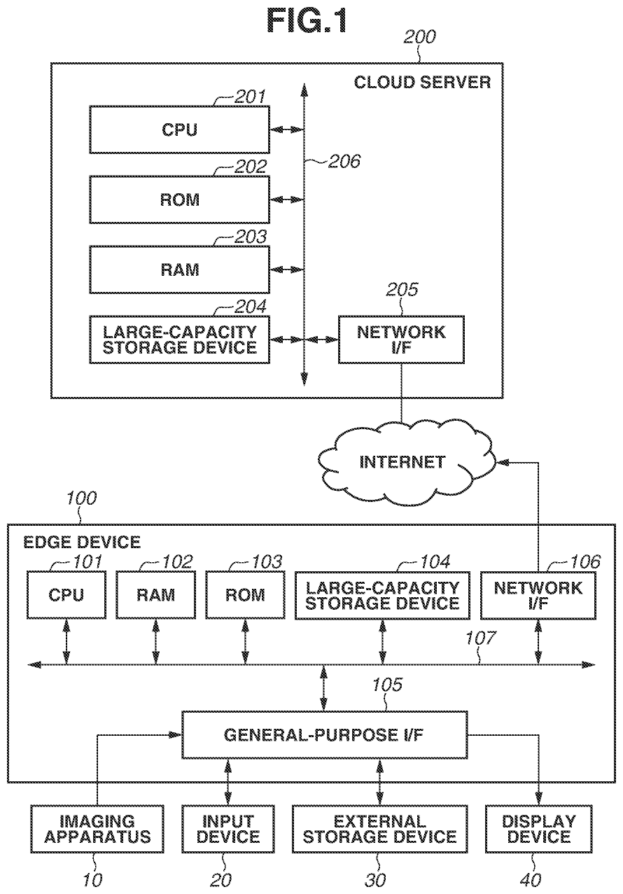

An example will now be described of a system configuration to which an information processing apparatus according to the first exemplary embodiment is applied with reference to FIG. 1. In an information processing system illustrated in FIG. 1, a cloud server 200 that functions to generate training data and learn the estimation and the restoration of image quality degradation, and an edge device 100 that functions to perform degradation restoration in a processing target image are connected together via the Internet. The generation of training data and the learning of the estimation and the restoration of image quality degradation performed by the cloud server 200 are also referred to as “degradation restoration learning”, and the degradation restoration performed by the edge device 100 is also referred to as “degradation restoration inference”.

### (Hardware Configuration of Edge Device)

The edge device 100 according to the present exemplary embodiment acquires raw image data (the Bayer arrangement) input from an imaging apparatus 10 as an input image as a target of an image restoration process. Then, the edge device 100 applies a learned model parameter provided by the cloud server 200 to the input image as the processing target to perform degradation restoration inference. In other words, the edge device 100 is an information processing apparatus that runs an information processing application program installed in advance on the edge device 100 using a neural network provided by the cloud server 200, thereby reducing noise in raw image data.

The edge device 100 includes a central processing unit (CPU) 101, a random-access memory (RAM) 102, a read-only memory (ROM) 103, a large-capacity storage device 104, a general-purpose interface (I/F) 105, and a network I/F 106, and these components are connected to each other via a system bus 107. The edge device 100 is also connected to the imaging apparatus 10, an input device 20, an external storage device 30, and a display device 40 via the general-purpose I/F 105.

The CPU 101 runs programs stored in the ROM 103 using the RAM 102 as a work memory to generally control the components of the edge device 100 via the system bus 107. For example, the large-capacity storage device 104 is embodied as a hard disk drive (HDD) or a solid-state drive (SSD) and stores various pieces of data and image data handled by the edge device 100. The CPU 101 writes data to the large-capacity storage device 104 and reads data stored in the large-capacity storage device 104 via the system bus 107.

For example, the general-purpose I/F 105 can be embodied as a serial bus interface based on a standard, such as Universal Serial Bus (USB), the Institute of Electrical and Electronics Engineers (IEEE) 1394, or High-Definition Multimedia Interface (HDMI®). The edge device 100 acquires data from the external storage device 30 (e.g., various storage media, such as a memory card, a CompactFlash (CF) card, a Secure Digital (SD) card, and a USB memory), via the general-purpose I/F 105. The edge device 100 also receives user instructions from the input device 20, such as a mouse or a keyboard, via the general-purpose I/F 105. The edge device 100 also outputs image data processed by the CPU 101 to the display device 40 (e.g., various image display devices, such as a liquid crystal display), via the general-purpose I/F 105. The edge device 100 also acquires data on a captured image (raw image) as a target of a noise reduction process from the imaging apparatus 10 via the general-purpose I/F 105.

The network I/F 106 is an interface for connecting to various networks, such as the Internet. For example, the edge device 100 may access the cloud server 200 using a web browser installed on the edge device 100 and acquire model parameters for degradation restoration inference.

### (Hardware Configuration of Cloud Server)

The cloud server 200 according to the present exemplary embodiment is an information processing apparatus that provides a network service, such as a so-called cloud service, on a network, such as the Internet. More specifically, the cloud server 200 generates training data, performs degradation restoration learning, and generates a trained model that stores a model parameter as the result of the learning and a network structure. Then, according to a request from the edge device 100, the cloud server 200 provides the generated trained model to the edge device 100.

The cloud server 200 includes a CPU 201, a ROM 202, a RAM 203, a large-capacity storage device 204, and a network I/F 205, and these components are connected to each other via a system bus 206.

The CPU 201 reads control programs stored in the ROM 202 to perform various processes, controlling the overall operation of the cloud server 200. The RAM 203 is used as a temporary storage area, such as a main memory or a work area for the CPU 201. The large-capacity storage device 204 is a large-capacity secondary storage device that stores image data and various programs, and for example, can be embodied as an HDD or an SSD. The network I/F 205 is an interface for connecting to various networks, such as the Internet. For example, according to a request from the web browser of the edge device 100, the network I/F 205 provides a trained model that stores a model parameter and a network structure to the edge device 100.

As the components of the edge device 100 and the cloud server 200, components other than the above components can also exist, but the description will be omitted here.

In the present exemplary embodiment, it is premised that the cloud server 200 transmits to the edge device 100 a trained model as a result of generating training data and performing degradation restoration learning, and the edge device 100 performs degradation restoration inference on input image data as a processing target.

The above system configuration is merely an example, and does not limit the configuration of the system to which the information processing apparatus according to the present exemplary embodiment is applied. For example, a configuration may be applied in which the function of the cloud server 200 is divided, and the generation of training data and degradation restoration learning is performed by separate apparatuses. As another example, a configuration may be applied in which an apparatus (e.g., the imaging apparatus 10) with both the function of the edge device 100 and the function of the cloud server 200 performs the generation of training data, degradation restoration learning, and degradation restoration inference.

### (Functional Configuration of Entirety of System)

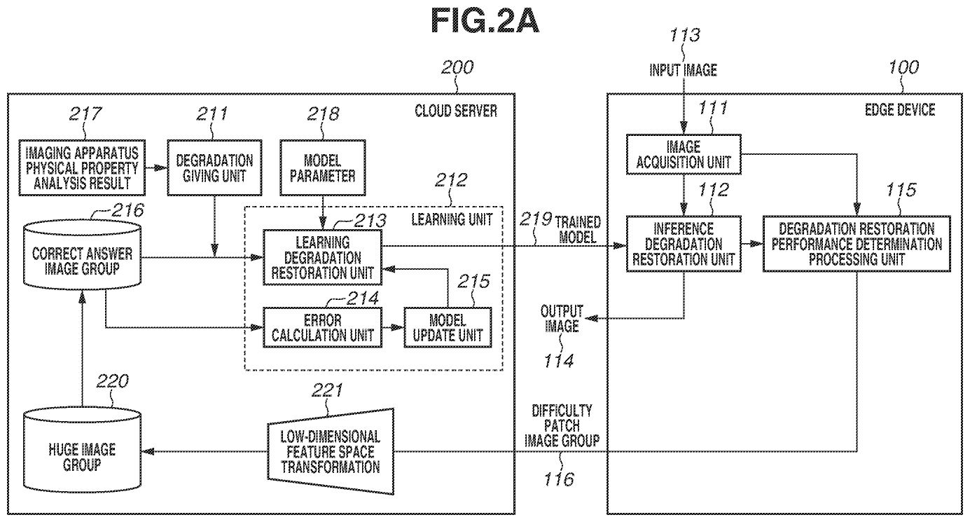

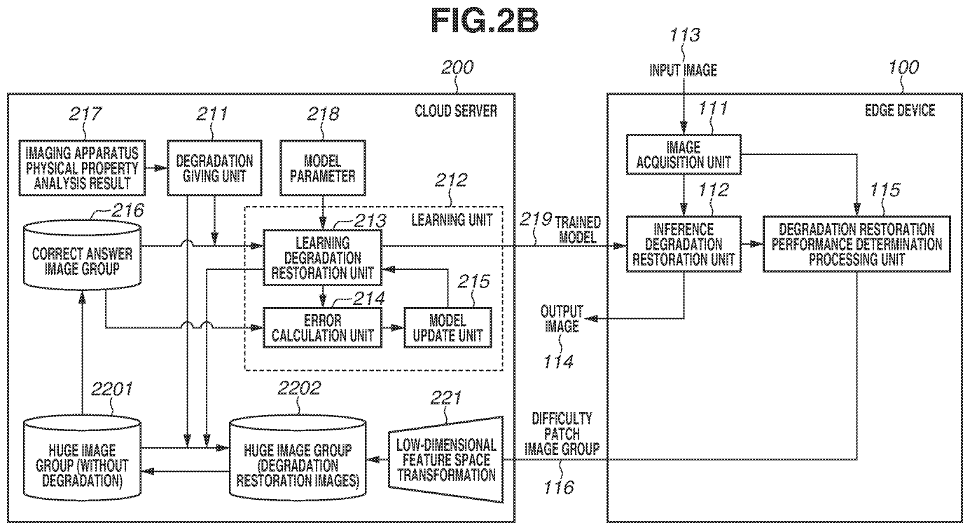

An example will now be described of the functional configuration of the whole of the information processing system according to the present exemplary embodiment with reference to FIG. 2A. As illustrated in FIG. 2A, the edge device 100 includes an image acquisition unit 111, an inference degradation restoration unit 112, and a degradation restoration performance determination processing unit 115. The cloud server 200 includes a degradation giving unit 211 and a learning unit 212. The learning unit 212 includes a learning degradation restoration unit 213, an error calculation unit 214, and a model update unit 215.

The configuration illustrated in FIG. 2A is merely an example, and can be appropriately modified or changed. For example, a single functional unit may be divided into a plurality of functional units, or two or more functional units may be integrated into a single functional unit. The configuration illustrated in FIG. 2A may be embodied as two or more apparatuses. In this case, the apparatuses may be connected to each other via a circuit or a wired or wireless network and cooperatively operate by communicating data with each other, providing processes according to the present exemplary embodiment.

First, the functional units of the edge device 100 will be described in detail.

The image acquisition unit 111 acquires an input image 113 as a processing target. The input image 113 may be a single image, or may be a plurality of chronologically successive images. As each input image 113, for example, raw image data in which each pixel has a pixel value corresponding to one of the RGB colors is used. The raw image data according to the present exemplary embodiment of the present disclosure is image data captured using color filters in the Bayer arrangement in which each pixel has information corresponding to a single color.

The inference degradation restoration unit 112 inputs the received one or more pieces of input image data to a trained model 219 transmitted from the cloud server 200 to cause the trained model 219 to perform degradation restoration inference. Then, the inference degradation restoration unit 112 outputs an output image 114 according to the result of the degradation restoration inference to a predetermined output destination. The output image 114 may also be a single image, or a plurality of chronologically successive images.

The degradation restoration performance determination processing unit 115 receives a degraded image input from the image acquisition unit 111 and an image equivalent to the output image 114 in which the degradation is restored by the inference degradation restoration unit 112. Based on the received degraded image and image in which the degradation is restored, the degradation restoration performance determination processing unit 115 determines whether the degradation restoration is appropriately performed in the image in the test environment (e.g., an environment where the edge device 100 is used). Then, the degradation restoration performance determination processing unit 115 determines a difficulty patch image group 116 that causes the determination that the degradation restoration is not appropriate in the test environment as the result of the determination. Then, the degradation restoration performance determination processing unit 115 transmits the difficulty patch image group 116 to the cloud server 200.

The difficulty patch image group 116 is transformed into feature amounts in a learned low-dimensional feature space by low-dimensional feature space transformation 221. Then, the difficulty patch image group 116 transformed into the low-dimensional feature amounts is input as a query to a huge image group 220. The query is intended to search for a similar image patch to additionally learn an image patch close to a difficulty patch that occurs in the test environment.

Then, according to the query, an image patch having a feature close to that of the difficulty patch image group 116 is added to a correct answer image group 216. The correct answer image group 216 is applied to the training of a model by the cloud server 200 in the following description, making it possible to obtain a model more favorable in degradation restoration performance in the test environment.

The functional units of the cloud server 200 will now be described.

An image to be applied to learning is uploaded to the cloud server 200. A data set of images to be applied to learning including this image is held as the correct answer image group 216 in the cloud server 200. It is desirable that a correct answer image group more appropriate as the correct answer image group 216 include, for example, an image obtained by capturing an image of an object closer to a target whose image to be captured in the test environment to which noise removal is applied, and further an image without degradation. In the present exemplary embodiment, similarly to the input image 113, correct answer image data is raw image data in which each pixel has a pixel value corresponding to one of the RGB colors.

An imaging apparatus physical property analysis result 217 includes, for example, the amount of noise in each sensitivity generated in an image sensor built into a camera (the imaging apparatus 10) and the amount of aberration generated by a lens. Using these amounts makes it possible to estimate to what extent image quality degradation is to occur by imaging condition. In other words, by giving degradation estimated under a certain imaging condition to correct answer image data makes it possible to generate an image equivalent to an image obtained when captured.

The degradation giving unit 211 gives at least one or more types of degradation factors to correct answer image data extracted from the correct answer image group 216 without degradation (or with a very little degradation) to generate degraded image data. Since noise is taken as an example of a degradation factor in the example of the present exemplary embodiment, the degradation giving unit 211 gives noise as a degradation factor to the correct answer image data to generate the degraded image data. Specifically, in the present exemplary embodiment, the degradation giving unit 211 reflects the imaging apparatus physical property analysis result 217 and gives noise corresponding to the amount of degradation in a range wider than that of the amount of degradation that can occur in the imaging apparatus 10 as a degradation factor to the correct answer image data to generate the degraded image data. The reason for giving the amount of degradation in a range wider than that of the analysis result is that the range of the amount of degradation differs due to individual differences among imaging apparatuses, and thus, robustness is increased with the margin.

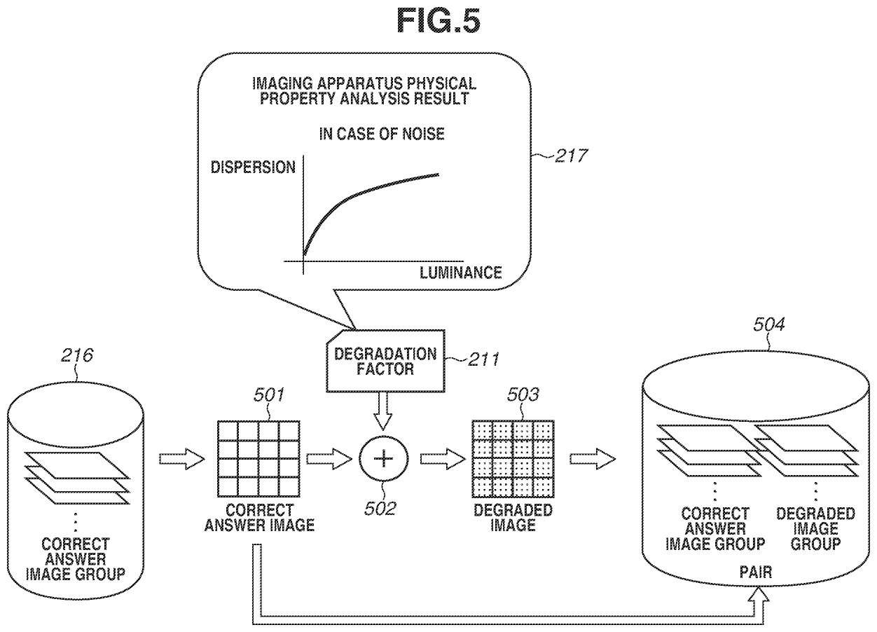

For example, FIG. 5 is a diagram illustrating processing regarding the generation of degraded image data by the degradation giving unit 211. As illustrated in FIG. 5, the degradation giving unit 211 gives noise based on the imaging apparatus physical property analysis result 217 as a degradation factor to correct answer image data 501 extracted from the correct answer image group 216 through an addition process 502, generating degraded image data 503. Then, the degradation giving unit 211 determines a pair of the correct answer image data 501 and the degraded image data 503 to be training data. The degradation giving unit 211 gives the degradation factor to each of pieces of correct answer image data in the correct answer image group 216, generating a degraded image group composed of a plurality of pieces of degraded image data. This generates training data 504.

Although noise is taken as an example in the present exemplary embodiment, the degradation giving unit 211 may give any of the above plurality of types of degradation factors, such as defocus, aberration, compression, low resolution, a defect, and contrast reduction due to the weather at the time when the image is captured, or the combination of a plurality of these degradation factors to the correct answer image data.

The learning unit 212 acquires a model parameter 218 to be applied to a CNN (a model) in degradation restoration learning, initializes the weight of the CNN using the model parameter 218, and then performs the degradation restoration learning on the degraded image group generated by the degradation giving unit 211. In other words, the learning unit 212 updates a parameter of a learning model (a CNN) for enhancing the image quality of an input image using training data, learning an image restoration process.

The model parameter 218 includes hyperparameters indicating the initial values of parameters of the neural network, the structure of the neural network, and the optimization method. The degradation restoration learning in the learning unit 212 is performed by the learning degradation restoration unit 213, the error calculation unit 214, and the model update unit 215.

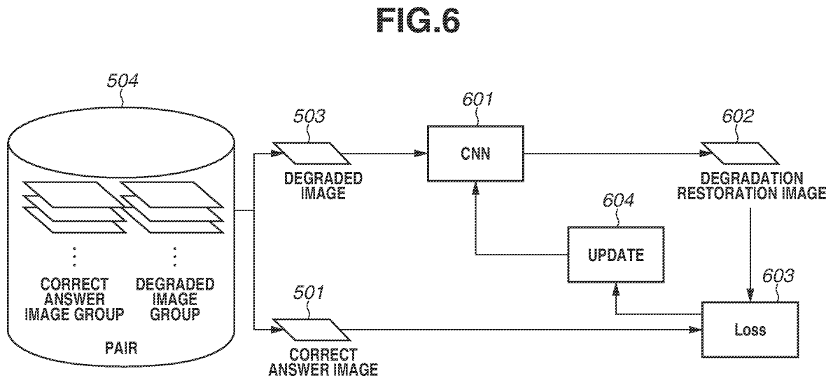

FIG. 6 is a diagram illustrating an example of the procedure of the processing of the learning unit 212.

The learning degradation restoration unit 213 receives the training data 504 including the set of the degraded image group created by the degradation giving unit 211 and the correct answer image group 216 and restores the degradation of the degraded image data 503. Specifically, the learning degradation restoration unit 213 inputs the degraded image data 503 to a CNN 601, repeats the convolution calculation and the non-linear calculation using the filter represented by equations (1) and (2) multiple times, and outputs degradation restoration image data 602 as a result of the calculations.

The error calculation unit 214 inputs the correct answer image data 501 and the degradation restoration image data 602 to Loss 603 (a calculation unit that calculates an error) and calculates the error between the correct answer image data 501 and the degradation restoration image data 602. The correct answer image data 501 and the degradation restoration image data 602 have the same number of pixels.

Next, the model update unit 215 inputs the error calculated by the error calculation unit 214 to an update process 604 and updates the model parameter 218 regarding the CNN 601 so that the error is small. The CNN 601 used by the learning unit 212 is the same neural network as a CNN used by the inference degradation restoration unit 112.

The description has been given above of a degradation restoration process on the input image 113 by the edge device 100 and the learning of the degradation restoration process by the cloud server 200 in the functional configuration of the entirety of the information processing system illustrated in FIG. 2A. A description is given below of an example of a functional configuration for further increasing the performance of the degradation restoration process by the edge device 100 in this mechanism.

When the edge device 100 performs inference in which the result of the learning by the cloud server 200 is reflected, the image acquisition unit 111 of the edge device 100 may receive the input image 113 having a tendency different from that learned by the cloud server 200. In such a case, the degree of the degradation restoration of the output image 114 output from the inference degradation restoration unit 112 may not reach a level that satisfies the user. As a result, the accuracy is enhanced (in other words, the performance is improved) by a method illustrated below.

The degradation restoration performance determination processing unit 115 receives the input image 113 acquired by the image acquisition unit 111 and an image output from the inference degradation restoration unit 112, identifies the difficulty patch image group 116 in which restoration performance is less than or equal to a threshold, and then transmits the identified difficulty patch image group 116 to the cloud server 200. Consequently, the degradation restoration performance determination processing unit 115 obtains a model favorable in degradation restoration performance in an edge environment (in other words, the test environment) from the cloud server 200.

The difficulty patch image group 116 transmitted from the edge device 100 to the cloud server 200 is transformed into feature amounts in a low-dimensional feature space based on a learned distance scale by the low-dimensional feature space transformation 221. Based on these feature amounts, the difficulty patch image group 116 is compared with vast image patches held in the huge image group 220 saved in the cloud server 200. The huge image group 220 is composed only of images having favorable image quality without degradation (or with a very little degradation).

To easily search for an image close to the difficulty patch image group 116, for example, it is desirable that coordinates in a low-dimensional feature space in which the similarities between the image patches that have been already reflected based on a predetermined criterion be assigned to images in the huge image group 220. On the other hand, a low-dimensional distance space based on the huge image group 220 and the difficulty patch image group 116 may be learned at the timing when the difficulty patch image group 116 is input.

A close image close to the input difficulty patch image group 116 is selected from the huge image group 220, and the selected image is added to the correct answer image group 216, whereby the model parameter 218 already learned by the learning unit 212 is updated similarly to the above learning. The updated trained model 219 is transmitted to the inference degradation restoration unit 112 of the edge device 100, allowing restoration of a degraded image using a favorable degradation restoration model tailored to the tendency of each input image 113 in the edge device 100.

### (Procedure of Processing of Entirety of System)

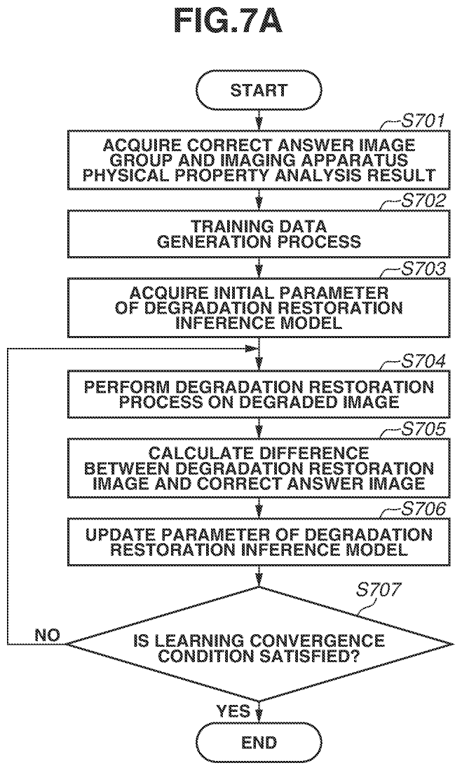

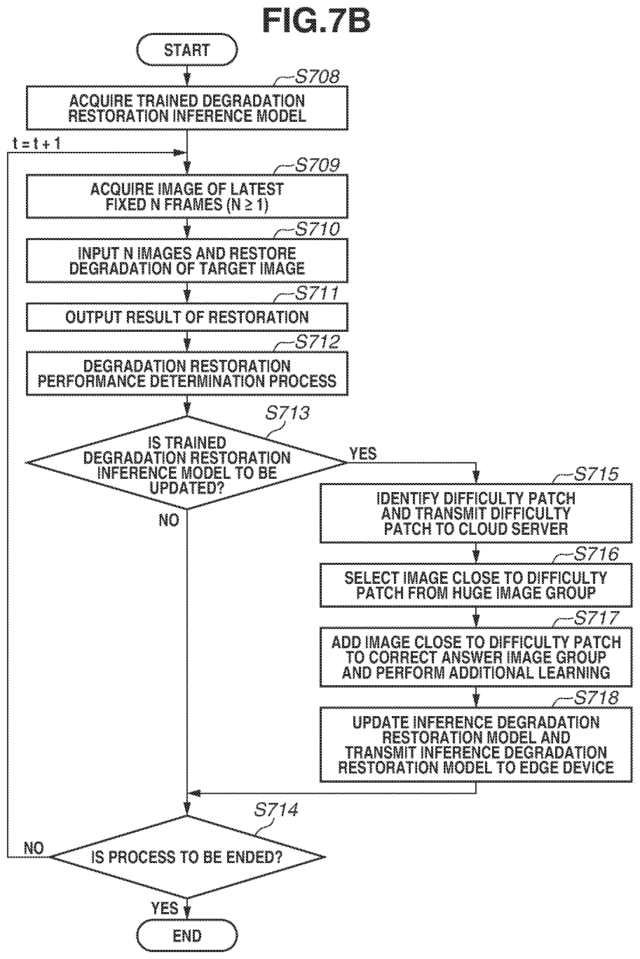

With reference to FIGS. 7A and 7B, an example will now be described of the processing of the information processing system according to the present exemplary embodiment. Each of FIGS. 7A and 7B is a flowchart illustrating an example of the procedure of the processing of the information processing system according to the present exemplary embodiment. The processing illustrated in FIGS. 7A and 7B is carried out by, for example, each of the CPUs 101 and 201 described with reference to FIG. 1 running an information processing computer program according to the present exemplary embodiment. All or some of the functional units illustrated in FIG. 2A, however, may be implemented by hardware. In this case, for example, at least a part of the processing illustrated in FIGS. 7A and 7B may be carried out by the hardware.

First, with reference to FIG. 7A, a description is given of an example of the procedure of a series of processes of degradation restoration learning by the cloud server 200.

In step S701, the cloud server 200 receives the inputs of the correct answer image group 216 prepared in advance, the properties of the image sensor, the sensitivity of the image sensor when each image is captured, the object distance, the focal length and the F-number of a lens, and the imaging apparatus physical property analysis result 217 per exposure level. This correct answer image data is raw images in the Bayer arrangement, and for example, can be obtained by the imaging apparatus 10 capturing images. In addition to raw images in the Bayer arrangement, images captured by the imaging apparatus 10 may be uploaded as they are, or images captured in advance and stored in a storage device, such as an HDD, may be uploaded. Then, the data on the correct answer image group 216 and the imaging apparatus physical property analysis result 217 input to the cloud server 200 are transmitted to the degradation giving unit 211.

In step S702, the degradation giving unit 211 gives noise based on the imaging apparatus physical property analysis result 217 to the correct answer image data on the correct answer image group 216 input in step S701, generating degraded image data. At this time, for example, the degradation giving unit 211 may give an amount of noise measured in advance based on the imaging apparatus physical property analysis result 217 to the correct answer image data in order set in advance or in random order. The degraded image data generated in step S702 is used as training data to train a model in processing separately described below.

In step S703, the cloud server 200 receives the input of the model parameter 218 to be applied to a CNN in the degradation restoration learning. As described above, the model parameter 218 includes the initial values of parameters obtained by putting together the weight and the bias of the neural network that lead to an optimal result after the learning. The input model parameter 218 is transmitted to the learning unit 212.

In step S704, the learning degradation restoration unit 213 initializes the weight of the CNN using the received model parameter 218 and then restores the degradation of the degraded image data generated in step S702.

In step S705, the error calculation unit 214 calculates the difference between the degradation restoration image data and the correct answer image data according to the loss function (the objective function) illustrated in equation (3).

In step S706, the model update unit 215 updates the model parameter 218 so that the difference between the degradation restoration image data and the correct answer image data obtained in step S705 is smaller (e.g., minimized).

In step S707, the learning unit 212 determines whether a learning convergence condition is satisfied. The learning convergence condition is not particularly limited, and can be appropriately set according to the use case.

As a specific example, whether the number of updates of the model parameter 218 in the learning unit 212 reaches a predetermined number of times may be set as the learning convergence condition.

If the learning unit 212 determines in step S707 that the learning convergence condition is not satisfied (No in step S707), the processing returns to step S704. In this case, in the processes of step S704 and the subsequent steps, learning using another piece of degraded image data and another piece of correct answer image data is performed.

Then, if the learning unit 212 determines in step S707 that the learning convergence condition is satisfied (Yes in step S707), the series of processes illustrated in FIG. 7A ends.

With reference to FIG. 7B, a description will now be given of an example of the procedure of a degradation restoration inference process by the edge device 100.

In step S708, the edge device 100 acquires the trained model 219 trained by the cloud server 200.

In step S709, the image acquisition unit 111 selects input image data on N frames (N≥1) from the input image 113 as a target of the degradation restoration inference process and generates pieces of input linked image data linked together in a channel direction. As the input image 113, for example, an image captured by the imaging apparatus 10 may be directly input, or an image captured in advance and stored in the large-capacity storage device 104 may be read. In the present exemplary embodiment, the “N frames” refer to N chronologically successive frames.

In step S710, the inference degradation restoration unit 112 constructs a CNN similar to the CNN used in the learning by the learning unit 212 and restores the degradation of the input linked image data. At this time, the inference degradation restoration unit 112 initializes the existing model parameter 218 based on the updated model parameter 218 received from the cloud server 200. As described above, the inference degradation restoration unit 112 inputs the input linked image data to the CNN to which the updated model parameter 218 is applied, and restores the degradation of the input image data by a method similar to the method performed by the learning unit 212, obtaining output image data.

In step S711, the edge device 100 outputs the output image data obtained in step S710 as the output image 114 to a predetermined output destination. As a specific example, the edge device 100 may output the output image 114 to the display device 40 illustrated in FIG. 1, displaying the output image 114 on the display device 40. As another example, the edge device 100 may output the output image 114 to the external storage device 30, saving the output image 114 in the external storage device 30.

In step S712, the degradation restoration performance determination processing unit 115 determines the degree of the restoration when the result of the restoration is output in step S711. As a specific example, in the output image 114 output as the result of the restoration, there may be an area where the degradation restoration is favorable and an area where the degradation restoration is not favorable. If there is an area where the degree of the degradation restoration is not favorable (e.g., an area where the degree of the degradation restoration is less than the required degree) in the test environment, it can be said that the current trained degradation restoration model has difficulty performing the degradation restoration inference process on an image of the area. As a result, in the present exemplary embodiment, the process of increasing the accuracy of an image restoration process in the test environment is performed by identifying an area where the degree of the degradation restoration is not favorable as a difficulty area based on a threshold set in advance. The process of increasing the accuracy of the image restoration process will be described as the processes of steps S712 to S718.

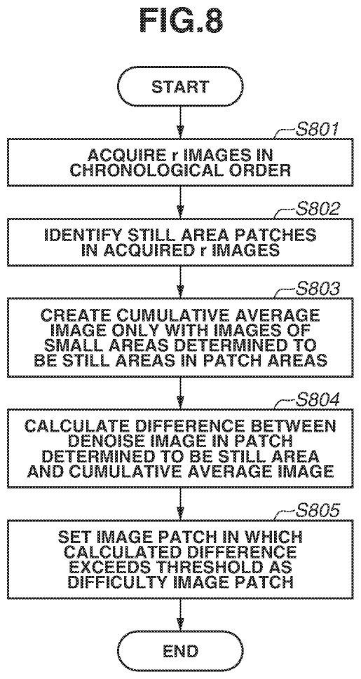

With reference to FIG. 8, an example will now be described of the degradation restoration performance determination process in step S712.

In step S801, the degradation restoration performance determination processing unit 115 acquires r images in chronological order (r is about 100, for example).

In step S802, the degradation restoration performance determination processing unit 115 divides the r successive images acquired in step S801 at vertical and horizontal regular intervals into small area sizes corresponding to image patches and determines whether each area is a still area with no motion. Examples of the simplest process of determining a motion include a method for making the determination based on the difference between temporally adjacent frames of the input images. For example, a case where noise is generated and a case where a target moves lead to different difference images, allowing use of only an area where the target does not remain still by small area in the r images.

In step S803, using small areas determined to be still areas in step S802 as a target, the degradation restoration performance determination processing unit 115 creates a cumulative average image for each area. Normally, the denoise result of a cumulative average image in a still area is very favorable.

In step S804, the degradation restoration performance determination processing unit 115 calculates the difference between the denoise result in an area determined to be a still area and the cumulative average image.

In step S805, the degradation restoration performance determination processing unit 115 determines that an image patch in which the difference calculated in step S804 exceeds a threshold is an image patch having a low denoise quality. If there is not an image patch in which the difference exceeds the threshold in step S805, it is determined that the degradation restoration performance is favorable. In this case, it is not necessary to update the trained degradation restoration inference model 219. On the other hand, if there is an image patch in which the difference exceeds the threshold in step S805, it is determined that the degradation restoration performance is low (e.g., does not satisfy the required accuracy), and the cumulative average image in the corresponding area is set as a difficulty patch image.

The example of the degradation restoration performance determination process illustrated in step S712 in FIG. 7B has been described above with reference to FIG. 8. Based on the result of this process, then in step S713, the degradation restoration performance determination processing unit 115 determines whether to update the trained degradation restoration inference model 219. Specifically, if there is an image patch in which the quality is low, the degradation restoration performance determination processing unit 115 determines that it is necessary to update the trained degradation restoration inference model 219.

If the degradation restoration performance determination processing unit 115 determines in step S713 that the trained degradation restoration inference model 219 is to be updated (Yes in step S713), the processing proceeds to step S715.

If, on the other hand, the degradation restoration performance determination processing unit 115 determines in step S713 that the trained degradation restoration inference model 219 is not to be updated (No in step S713), the processing proceeds to step S714.

In step S715, the degradation restoration performance determination processing unit 115 identifies the difficulty patch and transmits the difficulty patch to the cloud server 200. The difficulty patch identified in step S715 (i.e., an image patch corresponding to at least a partial area in an image as a target) is equivalent to an example of a partial image corresponding to an area in an image in which performance of inference by an inference unit (e.g., the trained degradation restoration inference model 219) is less than or equal to a threshold.

In step S716, the cloud server 200 compares vast image patches held in the huge image group 220 and the difficulty patch transmitted in step S715 and selects a patch image having a feature close to that of the difficulty patch from the huge image group 220.

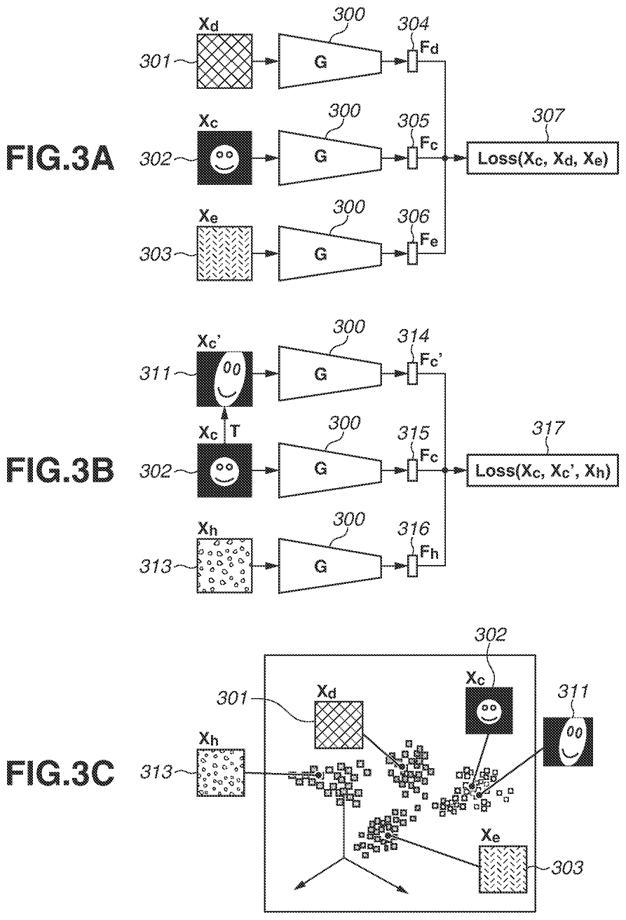

In step S716, the close patch can be selected from among the huge image group 220 already defined in a learned low-dimensional distance space by representing the above difficulty patch in a distance space similar to the learned low-dimensional distance space. This, however, requires a mechanism for appropriately learning this distance space. With reference to FIGS. 3A to 3C, a description will now be given of an example of a method for obtaining the low-dimensional distance space using the huge image group 220 held in advance.

To compare the similarities between the vast image patches in the huge image group 220 and image patches in the difficulty patch image group 116, it is desirable that a CNN be available which is capable of transforming an image patch into a low-dimensional feature space where a similarity can be calculated as a distance. As illustrated in in FIG. 3, this CNN 300 is a neural network to which image patches are input and from which coordinates in m dimensions (m≥1) in a learned distance space in which the similarities between the image patches are reflected are output. The CNN 300 in FIG. 3 is the same as a CNN that performs the low-dimensional feature space transformation 221 in FIG. 2A.

If the above CNN (hereinafter also referred to as a “trained image patch distance space transformation CNN”) is not available, the huge image group 220 is merely a data set of image patches. Even if the difficulty patch is acquired, it is difficult to select a patch similar to the difficulty patch from the huge image group 220. Thus, in the present exemplary embodiment, the huge image group 220 is defined as being accompanied by the trained image patch distance space transformation CNN.

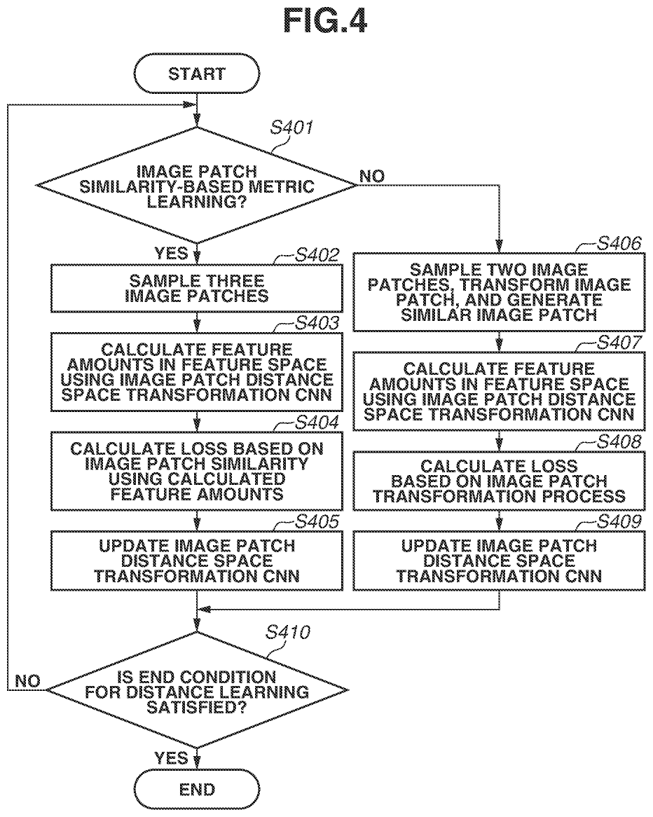

An example will now be described of the training procedure of the image patch distance space transformation CNN with reference to FIG. 4. Distance learning exemplified in FIG. 4 includes two types of metric learning between image patches. For simplicity, the two types are referred to as “image patch similarity-based metric learning” (steps S402 to S405) and “image patch transformation process-based metric learning” (steps S406 to S409).

First, the input to the image patch distance space transformation CNN is an input image defined by the sizes of the image patches held in the huge image group 220 as a current target. The greater the size of the input image is, the higher the dimension is. It is, however, desirable that the size of the input image be the same as those of image patches input to the learning degradation restoration unit 213 and the inference degradation restoration unit 112 in FIG. 2A. The output from the image patch distance space transformation CNN is a feature space dimensional vector in sufficiently lower dimensions than those of the input image. Basically, in this learning procedure, the similarity between images is calculated as a one-dimensional score and embedded in the feature space with reference to the distance between the images. Thus, the learning procedure is based on the premise of a low-dimensional space in about ten dimensions or lower.

At an early stage of the learning, the model parameter of the image patch distance space transformation CNN is initialized with a random numerical value.

In step S401, the learning unit 212 determines subsequent processing according to whether to perform the image patch similarity-based metric learning (or the image patch transformation process-based metric learning).

In other words, if the learning unit 212 determines in step S401 that the image patch similarity-based metric learning is to be performed (Yes in step S401), the processing proceeds to step S402.

If, on the other hand, the learning unit 212 determines in step S401 that the image patch similarity-based metric learning is not to be performed (No in step S401), the processing proceeds to step S406.

In the present exemplary embodiment, the above two types of metric learning are alternately performed based on the condition that certain learning converges to less than or equal to a threshold set in advance. First, the processing proceeds to the image patch similarity-based metric learning.

In step S402, the learning unit 212 samples three image patches from the image patches saved in the huge image group 220. The method for sampling three image patches is not particularly limited. In the present exemplary embodiment, three image patches are randomly sampled. FIG. 3A illustrates an image of a process from the input of three image patches to the image patch distance space transformation CNN in step S402 to the calculation of a score based on a loss function. These three image patches are referred to as “image patches Xc (302), Xd (301), and Xe (303)”.

In step S403, the learning unit 212 calculates feature amounts Fc (305), Fd (304), and Fe (306) in the current feature space using the current image patch distance space transformation CNN (300).

In step S404, the learning unit 212 calculates a loss Loss(Xc, Xd, Xe) 307 in FIG. 3A based on the distances in the feature space between the feature amounts Fc, Fd, and Fe and the similarities between the image patches Xc, Xd, and Xe. Loss(Xc, Xd, Xe) is defined as follows so that Loss(Xc, Xd, Xe) is reflected in the low-dimensional feature space with reference to the separately defined distance relationships between images based on the similarities between the images.

First, the learning unit 212 determines which of the image patches Xd and Xe is close to the image patch Xc. As an index for determining the closeness, for example, the similarity between images is used. In the present exemplary embodiment, the similarity between images is calculated based on score SSIM (structural similarity index measure) defined below.

Specifically, suppose that image patches between which the similarity is compared are represented as y with respect to x, the score SSIM is calculated using a relational expression illustrated in equation (5).

$$\begin{matrix}[ Math . 5 ] & \\ SSIM ( x , y ) = {[ l ( x , y ) ]}^{α} \times {[ c ( x , y ) ]}^{β} \times {[ s ( x , y ) ]}^{γ} & equation ( 5 )\end{matrix}$$

$$l ( x , y ) = \frac{2 {μ}_{x} {μ}_{y} + {c}_{1}}{{μ}_{x}^{2} + {μ}_{y}^{2} + {c}_{1}} , c ( x , y ) = \frac{2 {σ}_{x y} + {c}_{2}}{{σ}_{x}^{2} + {σ}_{y}^{2} + {c}_{2}} , s ( x , y ) = \frac{{σ}_{x y} + {c}_{3}}{{σ}_{x} {σ}_{y} + {c}_{3}}$$

$${c}_{1} = {( {K}_{1} L )}^{2} , {c}_{2} = {( {K}_{2} L )}^{2} , {c}_{3} = \frac{{c}^{2}}{2} {K}_{1} , {K}_{2} ≪ 1$$

In equation (5), l(x, y) represents a comparison term of the luminance, c(x, y) represents a comparison term of the contrast, and s(x, y) represents a comparison term of the structure. μₓ represents the luminance average of x[i], and μ_{y} represents the luminance average of y[i]. σₓ represents the standard deviation of x[i], and σ_{y} represents the standard deviation of y[i]. σ_{xy} represents the covariance of x[i] and y[i]. L represents the maximum amplitude and is 255 in the case of 8-bit representation.

If α=β=γ=1, the score SSIM is often used as the form of the following equation (6). Thus, a description will be given on the premise that the score calculated based on equation (6) is used.

$$\begin{matrix}[ Math . 6 ] & \\ SSIM ( x , y ) = \frac{( 2 {μ}_{x} {μ}_{y} + {c}_{1} ) ( 2 {σ}_{x y} + {c}_{2} )}{( {μ}_{x}^{2} + {μ}_{y}^{2} + {c}_{1} ) ( {σ}_{x}^{2} + {σ}_{y}^{2} + {c}_{2} )} & equation ( 6 )\end{matrix}$$

The similarity calculation method is not limited to a method for calculating the similarity based on the relational expression illustrated in equation (5), and various methods can be applied as long as the similarity can be calculated as a one-dimensional score. As a specific example, a method for obtaining the correspondence between feature points based on AKAZE, SIFT, or SURF and ultimately calculating the similarity as a one-dimensional score may be applied, or a method for defining the similarity based on a simple square error may be applied.

In the method based on the SSIM, with high values, it can be determined that the images are similar images. For example, if it is determined which of the image patches Xd and Xe is similar to the image patch Xc, the image patch with the higher score calculated with equation (5) may be determined to be the image patch more similar to the image patch Xc. In the following description, the image patch similar to the target (e.g., the image patch Xc) is also referred to as “Xp”, and the other image patch is also referred to as “Xn”. According to these designations, a low-dimensional feature vector corresponding to the image patch Xp and output from the image patch distance space transformation CNN is referred to as “Fp”, and a low-dimensional feature vector corresponding to the image patch Xn is referred to as “Fn”. An example of the loss score (307) based on the three image patches Xc, Xd, and Xe calculated in step S404 is represented by a relational expression illustrated below in equation (7).

$$\begin{matrix}[ Math . 7 ] & \\ Loss ( {X}_{c} , {X}_{d} , {X}_{e} ) = Loss ( {X}_{c} , {X}_{p} , {X}_{n} ) = max ( 0 , 1 - \frac{{s}^{- d ( {F}_{c} , {F}_{p} )}}{{s}^{- d ( {F}_{c} , {F}_{n} )} + α} ) , & equation ( 7 )\end{matrix}$$

$$s > 1 , α > 0 , s and α are constants$$

In the above equation (7), which of the image patches Xd and Xe is close to the image patch Xc based on the distances from the image patch Xc is determined, allowing calculation of Loss(Xc, Xd, Xe).

In other words, the image patch closer to the image patch Xc is determined to be the image patch Xp, and the other image patch is determined to be the image patch Xn. Then, distances d in the feature space between the outputs Fc, Fp, and Fn from the image patch distance space transformation CNN are obtained to calculate the loss. As a distance d(A, B), the Euclidean distance between A and B in the image patch distance space is premised, but another distance may be used.

The above loss score calculation is performed on a lot of combinations of the image patches Xc, Xd, and Xe to calculate the loss. As described above, in step S405, the learning unit 212 updates the model parameter of the image patch distance space transformation CNN in a direction that reduces the loss.

In step S410, the learning unit 212 determines whether an end condition for the distance learning is satisfied. As a specific example, if the magnitude of a reduction in the loss based on the loss function falls below a threshold set in advance, the learning unit 212 may determine that the end condition for the distance learning is satisfied.

If the learning unit 212 determines in step S410 that the end condition for the distance learning is not satisfied (No in step S410), the processing returns to step S401. In this case, the processes of step S401 and the subsequent steps, i.e., the image patch similarity-based metric learning or the image patch transformation process-based metric learning, are continued again.

Then, if the learning unit 212 determines in step S410 that the end condition for the distance learning is satisfied (Yes in step S410), the series of processes illustrated in FIG. 4 ends.

The image patch transformation process-based metric learning (steps S406 to S409) will now be described. In the case of the image patch similarity-based metric learning (steps S402 to S405), a calculation for learning a metric space for embedding the relationships between the image patches in a low-dimensional distance space is performed using the similarities between three randomly extracted image patches as one-dimensional distances. In contrast, in the case of the image patch transformation process-based metric learning in steps S406 to S409, image transformation is performed on one of two types of randomly extracted image patches to intentionally create a similar image patch. Through this method, the distance learning is performed by using a relative relationship where known similar image patches are closer to each other than to an image patch less related (or unrelated at all) to the known similar image patches.

In step S406, the learning unit 212 randomly extracts an image patch Xc (302) and an image patch Xh (313) as exemplified in FIG. 3B from the huge image group 220 and performs random image transformation on the image patch Xc to generate an image patch Xc′ (311). To the transformation process, for example, an affine transformation T can be applied.

In FIG. 3B, the image patch Xc′ (311) is an image obtained by performing a simple affine transformation on the image patch Xc (302). Thus, in step S407, the learning unit 212 calculates feature amounts Fc (315), Fc′ (314), and Fh (316) in the current feature space using a CNN that embeds the three image patches as a target in a low-dimensional distance space (the CNN 300 illustrated in FIG. 3 and the low-dimensional feature space transformation 221 illustrated in FIG. 2A).

The learning unit 212 also performs learning to obtain a distance space where the feature amounts Fc′ (314) and Fc (315) are close to each other and the feature amount Fh (316) is located further away from the feature amounts Fc′ (314) and Fc (315) in the feature space in the relationships between the feature amounts Fc (315), Fc′ (314), and Fh (316). An example of a loss score LOSS (317) based on the three image patches calculated at this time in step S408 is illustrated below in equation (8).

$$\begin{matrix}[ Math . 8 ] & \\ Loss ( {X}_{c} , {X}_{{c}^{′}} , {X}_{h} ) = max ( 0 , 1 - \frac{{q}^{- d ( {F}_{c} , {F}_{{c}^{′}} )}}{{q}^{- d ( {F}_{c} , {F}_{h} )} + β} ) , & equation ( 8 )\end{matrix}$$

$$q > 1 , β > 0 , v and β are constants$$

In the above equation (8), the loss in view of the distances to the image patches Xc′ and Xh is calculated based on the distances from the image patch Xc. Regarding equation (8), distances d in the feature space between the outputs Fc, Fc′, and Fh from the image patch distance space transformation CNN are obtained to calculate the loss. As the distance d, similarly to the above equation (7) for the distance d(A, B), the Euclidean distance between A and B in the image patch distance space is premised, but another distance may be used. The above loss score calculation is performed on a lot of combinations of the image patches Xc, Xc′, and Xh to calculate the loss. In equation (8), compared to equation (7), a close image patch is always input, and thus, it is suitable that the relative magnitude relationship between s in equation (7) and q in equation (8) is s<q. In this case, however, it is desirable to perform control not to perform transformation at a level that significantly impairs the properties of the original input image in the affine transformation T.

Based on the above, in step S409, the learning unit 212 updates the model parameter of the image patch distance space transformation CNN in a direction that reduces the loss.

Then, in step S410, the learning unit 212 determines whether the end condition for the distance learning is satisfied. The process of step S410 has been described above, and is not described in detail.

The description has been given above of an example of the training procedure of the image patch distance space transformation CNN by performing both the image patch similarity-based metric learning and the image patch transformation process-based metric learning. Consequently, two types of learning are performed: distance learning in which different image patches are compared with each other based on an existing image similarity-based distance scale termed SSIM, and distance learning in which a similar image patch that can be generated by transforming a certain image patch is embedded closer to the certain image patch than a different image patch.

As a result of continuing the above processing until the learning satisfies the end condition, an image patch data set is ultimately acquired that holds the coordinates in the low-dimensional feature space where the closeness relationships between the image patches in the huge image group 220 are learned. The similar patch generated in step S406 may or may not be included in the huge image group 220 in which the distance relationships are defined.

The description has been given above of an example of a method for performing distance learning using a CNN to obtain a distance space for the image patches in the huge image group 220. The method, however, is not limited to the above example, and various methods for performing distance learning are discussed.

For example, Fisher discriminant analysis (FDA) as a linear dimensionality reduction technique can also be used. In this case, a different image patch may be regarded as a different class, and an image patch generated by an affine transformation may be regarded as the same class. Then, a linear projection matrix that makes intra-class dispersion small and makes inter-class dispersion large may be obtained, and the obtained projection matrix may be used as the low-dimensional feature space transformation 221 illustrated in FIG. 2A.

Alternatively, transformation into a non-linear low-dimensional feature space may also be applied. Specifically, if a space is newly defined based on the difficulty patch image group 116 newly input at each timing when the low-dimensional feature space transformation 221 is performed, the purpose can also be achieved by performing isometric mapping (Isomap) each time.

By the above method, a distance space between a vast number of image patches held within the huge image group 220 is defined in advance. As a result, based on the advance definition of the distance relationships between all the image patches, a close image close to the difficulty patch image group 116 input as a query can be quickly selected from among the huge image group 220.

The difficulty patch image group 116 is transformed into low-dimensional feature amounts in a learned distance space by the low-dimensional feature space transformation 221 to select a close image close to a difficulty patch image. Then, a predetermined number of image patches present near the low-dimensional feature amounts are selected. In this selection, for example, if it is necessary to collect P close image patches, P feature points may be selected in order from the nearest neighbor feature point in the distance space, and image patches associated with the P feature points may be selected.

To the above distance, a Euclidean distance criterion may be applied as the simplest example. The above distance, however, is not limited to this.

The description has been given above of an example of a method for learning a low-dimensional distance space in advance to select an image close to the difficulty patch image group 116 from the huge image group 220 in step S716. The processing procedure after step S716 will now be described with reference to FIG. 7B.

In step S717, the cloud server 200 adds the patch selected in step S716 (hereinafter also referred to as the “close-to-difficulty-patch image”) to the training correct answer image group 216. An image including at least the close-to-difficulty-patch image and added to the training correct answer image group 216 is equivalent to an example of an additional image. Then, after adding the close-to-difficulty-patch image to the training correct answer image group 216, the cloud server 200 performs processing similar to that of the learning procedure described above. Then, if the learning converges, then in step S718, the cloud server 200 updates the inference degradation model 219 and transmits the updated model 219 to the inference degradation restoration unit 112 of the edge device 100. By the above processing, the model 219 of the inference degradation restoration unit 112 is updated according to the tendency of an input image in the test environment. This leads to an expectation to enhance the accuracy of the degradation restoration in the test environment (in other words, an improvement in the degradation restoration performance).

In step S714, the edge device 100 determines whether to end the degradation restoration inference process. The determination of whether to end the degradation restoration inference process in step S714 may be made, for example, based on whether an instruction to end the image restoration process is received from the user through the input device 20.

If the edge device 100 determines in step S714 that the degradation restoration inference process is not to be ended (No in step S714), the processing returns to step S709. In this case, the processes of step S709 and the subsequent steps are performed again using the next frame as a target. As described above, the processes of step S709 and the subsequent steps are repeatedly performed until it is determined in step S714 that the degradation restoration inference process is to be ended. Through this process, an area where the degradation restoration performance is not favorable is determined at any time by the degradation restoration performance determination process in step S712, and additional learning continues to be performed each time, maintaining a degradation restoration inference model tailored to a change in the test environment.

Then, if the edge device 100 determines in step S714 that the degradation restoration inference process is to be ended (Yes in step S714), the series of processes illustrated in FIG. 7B ends.

The description has been given of an example where training data is generated in step S702 in FIG. 7A. Alternatively, the training data may be generated at a timing after step S702. Specifically, a configuration may be employed in which degraded image data corresponding to the correct answer image data is generated in the subsequent degradation restoration learning.

In the present exemplary embodiment, the description has been given of the example of the case where learning is performed from scratch using data on a correct answer image group prepared in advance. Alternatively, the processing according to the present exemplary embodiment may be performed based on a learned model parameter.

In the present exemplary embodiment, the case has been described where raw image data captured using color filters in the Bayer arrangement is used as a target. Alternatively, another color filter arrangement may be applied. Although raw image data has a single channel, pixels may be rearranged in the order of R, G1, G2, and B in a color filter arrangement. In this case, the data structure is H×W×4. If N=3, the data structure is H×W×12 by linking pieces of raw image data. The data format of an image is not limited to a raw image, and for example, may be an RGB image subjected to demosaic processing or an image through YUV conversion.

In the present exemplary embodiment, the description has been given taking noise as an example of the degradation factor. The degradation factor, however, is not limited to this. Even if the degradation factor includes degradation as described above due to defocus, aberration, compression, low resolution, a defect, or contrast reduction under the influence of fog, haze, snow, or rain when the image is captured, or the combination of these, the issue can be solved by a similar method.

The description has been given on the premise that a model trained by deep learning or machine learning is applied to artificial intelligence (AI) for enhancing image quality according to the present exemplary embodiment. This, however, does not necessarily limit the technique for achieving this AI. That is, the model trained by deep learning or machine learning can also be applied to any other technique capable of enhancing image quality.

A variation form of the first exemplary embodiment will be described as a second exemplary embodiment of the present disclosure.

Specifically, in the first exemplary embodiment, the case has been described where an image patch of an area where the accuracy of the image quality restoration is less than or equal to the threshold in the test environment (i.e., an area where the accuracy of the restoration performance is not favorable) is selected, and additional learning is performed as an example of the restoration of a degraded image. In the present exemplary embodiment, a description is given of an example of a technique for solving the issue by a method for selecting a close-to-difficulty-patch image having a feature close to that of an image patch of an area where the accuracy of the image quality restoration is less than or equal to the threshold, by using a degradation restoration image.

In the present exemplary embodiment, the hardware configuration of an edge device is substantially similar to that in the first exemplary embodiment. Thus, in the present exemplary embodiment, a description is given focusing on processes and functional components of an information processing system different from those in the first exemplary embodiment, and portions substantially similar to those of the first exemplary embodiment are not described in detail.

In the first exemplary embodiment, with reference to FIG. 2A, the description has been given of the method for setting the huge image group 220 as an image group composed of images with less degradation (or without degradation), searching the image group for an image close to the test environment, and adding a found close image. In contrast, in the present exemplary embodiment, the functional configuration of the entirety of the information processing system is as illustrated in FIG. 2B, and a series of huge image groups is managed separately as a huge image group (without degradation) 2201 and a huge image group (degradation restoration images) 2202.

The huge image group (without degradation) 2201 illustrated in FIG. 2B is substantially similar to the huge image group 220 illustrated in FIG. 2A. In contrast, the huge image group (degradation restoration images) 2202 stores an image group obtained as follows. The degradation giving unit 211, which gives degradation to the huge image group (without degradation) 2201 when normal learning is performed, degrades images in the huge image group (without degradation) 2201, and the learning degradation restoration unit 213 restores the degraded images, obtaining the image group. As a matter of fact, it is desirable that the numbers of images stored in the huge image group (without degradation) 2201 and the huge image group (degradation restoration images) 2202 match each other. The series of degradation restoration images in the huge image group (degradation restoration images) 2202 and the images without degradation in the huge image group (without degradation) 2201 based on which the degradation restoration images are created are managed in association with each other on a one-on-one basis.

A model used to restore the degraded images by the learning degradation restoration unit 213 is the same as a model used to perform image degradation restoration by the inference degradation restoration unit 112 in the test environment at that time. At the timing when the trained model 219 is updated in the subsequent additional learning procedure, the images in the huge image group (degradation restoration images) 2202 are updated.

Thus, the series of huge image groups is separated into the huge image group (without degradation) 2201 and the huge image group (degradation restoration images) 2202, and the huge image group (degradation restoration images) 2202 composed of the degradation restoration images is searched for an image patch close to a difficulty image. In other words, the images in the huge image group (degradation restoration images) 2202 composed of the degradation restoration images are held as an image group to which the distance relationships defined in the low-dimensional feature space are given by the distance learning illustrated in the processing procedure illustrated in FIG. 4 described in the first exemplary embodiment. Then, in the process of step S712 in FIG. 7B, it is determined whether the degradation restoration performance in the test environment is favorable. Then, if the degradation restoration performance determination processing unit 115 determines in step S713 that it is necessary to update the model 219, then in step S715, a degradation restoration patch itself of an image patch in which the level of the image quality degradation restoration is not high is transmitted as the difficulty patch image group 116 to the cloud server 200. In step S716, the coordinates in the low-dimensional feature space of the huge image group (degradation restoration images) 2202 are calculated by the low-dimensional feature space transformation 221, and an image close to a difficulty patch is selected by processing similar to that in the first exemplary embodiment.

On the other hand, since the close-to-difficulty-patch image selected in step S716 is a degradation restoration image, it is not desirable to add this image group as it is as training data. Thus, the original image with less degradation (or without degradation) of the selected close-to-difficulty-patch image is identified from the huge image group 2201 and added to the correct answer image group 216. The following processing procedure (e.g., the procedure of additional learning) is similar to that in the first exemplary embodiment.

In the present exemplary embodiment, the description has been given taking noise as an example of the degradation factor. The degradation factor, however, is not limited to this. Even if the degradation factor includes degradation as described above due to defocus, aberration, compression, low resolution, a defect, or contrast reduction under the influence of fog, haze, snow, or rain when the image is captured, or the combination of these, the issue can be solved by a similar method.

The description has been given on the premise that a model trained by deep learning or machine learning is applied to AI for enhancing image quality according to the present exemplary embodiment. This, however, does not necessarily limit the technique for achieving this AI. That is, the model trained by deep learning or machine learning can also be applied to any other technique capable of enhancing image quality.

A variation form of the first exemplary embodiment will be described as a third exemplary embodiment of the present disclosure.

Specifically, in the first exemplary embodiment, the case has been described where an image patch of an area where the accuracy of the image quality restoration is not favorable in the test environment is selected, and additional learning is performed as an example of the restoration of a degraded image.

In the present exemplary embodiment, a description is given of an example of a method for identifying an area where learning is insufficient not in the test environment but in the learning process, selecting a training patch for increasing the image restoration performance decreased due to the insufficiency of the learning, and expanding a training data set. The present exemplary embodiment is an exemplary embodiment focusing only on learning, and thus, a cloud server and an edge device are not distinguished from each other. In the present exemplary embodiment, for convenience, various descriptions are given on the premise that an information processing system performs processes unless the cloud server and the edge device are distinguished from each other.

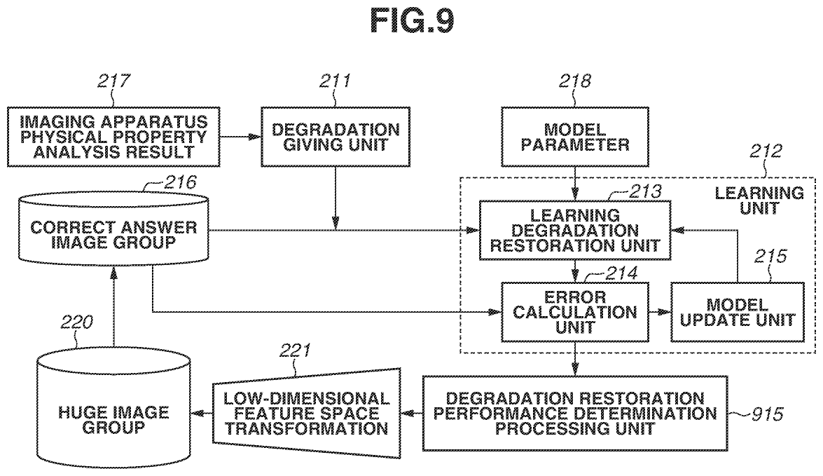

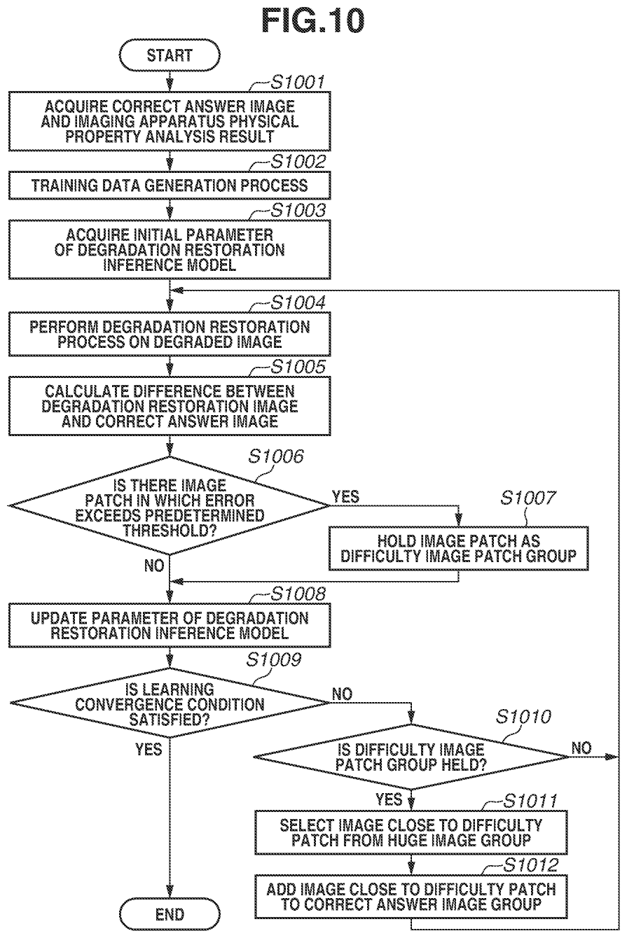

The following description is given by associating functional blocks and a processing procedure. FIG. 9 is a functional block diagram illustrating an example of the functional configuration of the information processing system according to the present exemplary embodiment. FIG. 10 is a flowchart illustrating an example of the processing of the information processing system according to the present exemplary embodiment. In the functional block diagram illustrated in FIG. 9, functional components substantially similar to the functional components illustrated in FIG. 2A are denoted by the same reference numerals. Thus, the functional components denoted by the same reference numerals as those in the example illustrated in FIG. 2A are not described in detail. As illustrated in FIG. 9, the information processing system according to the present exemplary embodiment is particularly different from that according to the first exemplary embodiment in that a degradation restoration performance determination processing unit 915 lies between the error calculation unit 214 and the low-dimensional feature space transformation 221 because corresponding processing is performed in the learning process.

In the training of a CNN related to image generation, it is difficult to predict what training image should be prepared in advance to obtain sufficient performance. In normal learning, learning influenced by a potential bias in a training data set can be performed. As a result, even if the training data set includes training images in which image degradation restoration is not sufficient, the number of the training images being small, it is difficult to reflect more information in the learning of a difficulty image patch. Thus, under such a situation, the learning of a particular small number of difficulty image patches may not proceed positively.

The restoration level in such a case where an image similar to a difficulty image patch of which the degradation restoration is insufficient when the learning is performed is input in the test environment similarly remains at an insufficient restoration level. Thus, in the present exemplary embodiment, a description is given of an example of a method for adding an image patch of which the image restoration is insufficient and which is identified during the learning process, at an appropriate timing in the middle of the learning, enhancing the overall image degradation restoration performance.

As illustrated in FIG. 9, the information processing system according to the present exemplary embodiment includes the degradation giving unit 211 and the learning unit 212. The learning unit 212 includes the learning degradation restoration unit 213, the error calculation unit 214, and the model update unit 215. Similarly to the example illustrated in FIG. 2A, the configuration illustrated in FIG. 9 can also be appropriately modified or changed. For example, a single functional unit may be divided into a plurality of functional units, or two or more functional units may be integrated into a single functional unit. The configuration illustrated in FIG. 9 may be composed of two or more apparatuses. In this case, the apparatuses may be connected to each other via a circuit or a wired or wireless network and cooperatively operate by communicating data with each other, carrying out processes according to the present exemplary embodiment.

In step S1001, the information processing system acquires a correct answer image input from the correct answer image group 216 and the imaging apparatus physical property analysis result 217.

In step S1002, the information processing system performs a training data generation process using a set of a degraded image to which degradation is given by the degradation giving unit 211 and in which the imaging apparatus physical property analysis result 217 is reflected, and the correct answer image.

In step S1003, the learning degradation restoration unit 213 acquires the model parameter 218 to be applied to a CNN in the degradation restoration learning.

In step S1004, the learning degradation restoration unit 213 performs an image degradation restoration process defined by the model parameter 218 (the initial model parameter) acquired in step S1003.

In step S1005, the error calculation unit 214 calculates the error between an image after the degradation restoration process and the correct answer image.

In step S1006, the degradation restoration performance determination processing unit 915 determines whether there is an image patch in which the error calculated in step S1005 exceeds a threshold.

If the degradation restoration performance determination processing unit 915 determines in step S1006 that there is an image patch in which the error exceeds the threshold (Yes in step S1006), the processing proceeds to step S1007. In this case, in step S1007, the degradation restoration performance determination processing unit 915 holds the image patch in which the error exceeds the threshold as a difficulty image patch group. Then, the processing proceeds to step S1008.

If, on the other hand, the degradation restoration performance determination processing unit 915 determines in step S1006 that there is no image patch in which the error exceeds the threshold (No in step S1006), the processing proceeds to step S1008. In this case, the process of step S1007 is skipped.

In step S1008, at the timing when the calculation of the error is completed regarding the series of pieces of training data, the model update unit 215 updates the inference model parameter 218 to minimize the image degradation restoration error based on the current model parameter 218.

In step S1009, the information processing system determines whether a learning convergence condition is satisfied.

If the information processing system determines in step S1009 that the learning convergence condition is satisfied (Yes in step S1009), the series of processes illustrated in FIG. 10 ends.

If, on the other hand, the information processing system determines in step S1009 that the learning convergence condition is not satisfied (No in step S1009), the processing proceeds to step S1010.

In step S1010, the information processing system determines whether a difficulty image patch group is held in step S1007 by the error calculated in step S1005 exceeding the threshold in the previous learning process.

If the information processing system determines in step S1010 that a difficulty image patch group is held (Yes in step S1010), the processing proceeds to step S1011.

If, on the other hand, the information processing system determines in step S1010 that a difficulty image patch group is not held (No in step S1010), the processing returns to step S1004. In this case, the restoration of a degraded image and learning processing according to the result of the restoration in and after step S1004 are performed again.

In step S1011, the information processing system selects an image similar to the difficulty image patch from the image patch data set in the huge image group 220. The image similar to the difficulty image patch can be selected as a close image in the learned low-dimensional distance space by transforming the image into a learned low-dimensional distance space by the low-dimensional feature space transformation 221. The low-dimensional distance space is substantially similar to that described above in the first exemplary embodiment, and is not described in detail.

In step S1012, the information processing system adds the image patch similar to the difficulty image patch and selected in step S1011 to the correct answer image group 216. Then, the processing returns to step S1004. In this case, in view of the update result of the training data set, the restoration of a degraded image and learning processing according to the result of the restoration in and after step S1004 are performed again.

In learning for the purpose of image restoration, the degradation giving unit 211 can give a degradation pattern to an image patch held in the correct answer image group 216 in the learning process. Thus, if a patch having difficulty in image restoration is identified in the learning process, an image close to the image patch is selected from the huge image group 220 as appropriate and is added, allowing detailed learning of an image patch having difficulty in image restoration due to insufficient learning. The processing of the degradation restoration performance determination processing unit 915 can be performed more simply than the details of the processing performed on the test image in the first exemplary embodiment.

The error calculation unit 214 calculates the error between a correct answer image acquired from the correct answer image group 216 in the learning process and an image obtained by the degradation giving unit 211 degrading the correct answer image and by the learning degradation restoration unit 213 restoring the degraded correct answer image and inputs the calculated error to the degradation restoration performance determination processing unit 915. Thus, based on an error image input to the degradation restoration performance determination processing unit 915, information on an image patch of an area where the image degradation restoration performance is less than or equal to the threshold is identified. Since a corresponding correct answer image patch is already acquired, the purpose is achieved by automatically inputting the correct answer image patch as a difficulty image patch to the low-dimensional feature space transformation 221.

Also in the present exemplary embodiment, similarly to the first exemplary embodiment, the degradation factor is not limited to noise. Even if the degradation factor includes degradation as described above due to defocus, aberration, compression, low resolution, a defect, or contrast reduction under the influence of fog, haze, snow, or rain when the image is captured, or the combination of these, the issue can be solved by a similar method.

The description has been given on the premise that a model trained by deep learning or machine learning is applied to AI for enhancing image quality according to the present exemplary embodiment. This, however, does not necessarily limit the technique for achieving this AI. In other words, the model trained by deep learning or machine learning can also be applied to any other technique capable of enhancing image quality.

A variation form of the first exemplary embodiment will be described as a fourth exemplary embodiment of the present disclosure.

Specifically, in the first exemplary embodiment, the case has been described where an image patch of an area where the accuracy of the image quality restoration is less than or equal to the threshold in the test environment (i.e., an area where the accuracy of the restoration performance is not favorable) is selected, and additional learning is performed as an example of the restoration of a degraded image. In the present exemplary embodiment, a description is given of a specific exemplary embodiment for performing the detection and the tracking of a person.

A configuration substantially similar to that according to the first exemplary embodiment is applicable to a system configuration to which an information processing apparatus according to the fourth exemplary embodiment is applied. In other words, the system configuration can be represented as a configuration as illustrated in FIG. 1. Thus, in the information processing system illustrated in FIG. 1, the cloud server 200 that functions to estimate and learn person detection and tracking, and the edge device 100 that functions to estimate person detection and tracking in a processing target image are connected together via a network, such as the Internet.

In person detection and tracking according to the present exemplary embodiment, person monitoring is performed in the following form. If an image is input, a person is detected in the image, the same person is tracked so long as the same person continues to be captured by the camera, and the same person identifier (ID) continues to be assigned to the same person.

First, the overview of an algorithm for the person detection and tracking according to the present exemplary embodiment will be described. In the information processing system according to the present exemplary embodiment, if a moving image is input, a person detection CNN performs person detection on an image of a single frame and continuously performs the person detection on each frame. Then, to use chronological relationship information on images, a plurality of frame images and the result of a detection map obtained by the person detection CNN are input to a person tracking CNN, whereby the person tracking CNN assigns the same ID to the same person.

The above algorithm, for example, for a monitoring purpose, achieves the function of counting the number of people in the time of a target moving image or retrospectively searching for a person that has behaved abnormally.

Similarly to the first exemplary embodiment, a description is given of an example of a case where a person image is input in the test environment in the state where a training data set does not include an image having the same tendency as that of the person image, or includes only a few images having the same tendency as that of the person image, which will lead to failure of person detection and tracking.

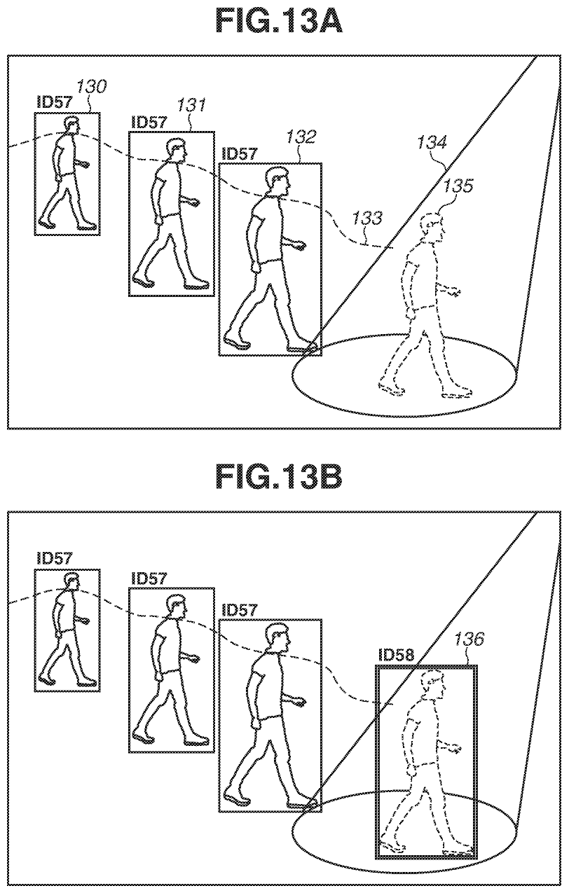

FIG. 13A is a diagram illustrating a situation where the same person chronologically walks from a top-left area to a bottom-right area, with detection/tracking results corresponding to four frames of a moving image superimposed on a single image. In this case, if a person without a track record proven to have been detected is detected in the top-left area by entering the angle of view for the first time, a rectangular area 130 corresponding to the person (in other words, a detection frame of the person as the target) is identified based on the result of the detection. In this case, an ID different from the IDs assigned to people detected in the past is assigned to the person indicated by the rectangular area 130. For example, in the example illustrated in FIG. 13A, an ID “57” is newly assigned to the person indicated by the rectangular area 130.

Also in the next frame, the same person is detected, and a rectangular area 131 corresponding to the person is identified. At this time, based on whether the feature amount of the rectangular area 130 in the previous frame and the feature amount of the rectangular area 131 are similar to each other, the tracking CNN determines whether the persons indicated by the rectangular areas 130 and 131 are the same person. In the example illustrated in FIG. 13A, it is determined that the persons indicated by the rectangular areas 130 and 131 are the same person. As a result, the ID “57” is assigned to the person indicated by the rectangular area 131.

In person tracking, if persons in detection frames are the same in a chronological direction, the continuous assignment of the same ID may be required for a monitoring purpose. There are, however, some cases where person detection and tracking fail.

The example illustrated in FIG. 13A schematically illustrates a situation where an area 134 where the illumination environment changes greatly compared with the other areas is present in the same angle of view, and the person as the target of the person detection and tracking enters the area 134. Specifically, a person 135 is equivalent to a person indicated by a rectangular area 132 in the previous frame and enters the area 134 through the subsequent movement. In this case, although the person 135 was detected as the person indicated by the rectangular area 132 in the previous frame, the feature of the person 135 is lost in the image according to the entry to the area 134, which can bring about an event where the person 135 is not detected. As a factor in the occurrence of such an event, a situation is conceivable where images similar to an image of the person 135 that has entered the area 134 are insufficient in training data for the person detection CNN. Generally, a situation is not conceivable where the person disappears in the same angle of view. Thus, it can be considered that the issue is solved by adding an image having an external appearance close to that of an image in a rectangle analogized based on a trajectory 133 of the person tracking from the previous frame to training images.

The example illustrated in FIG. 13B schematically illustrates a situation where a person that was regarded as the same person and correctly tracked in the past three frames moves as the target to an area where the illumination environment changes, making the person determined to be another person. Specifically, in the past three frames, the person as the target of the person detection and tracking is regarded as the same person, and the same ID “57” is assigned to each of the past three frames. On the other hand, although a person indicated by a rectangular area 136 is the same person as the person to which the ID “57” was assigned in the past three frames, when the person enters an area where the illumination environment changes, the external appearance of the person changes (i.e., the feature of the person visible on the image changes). As a result, the person tracking CNN cannot determine the person indicated by the rectangular area 136 and the person to which the ID “57” was assigned in the past three frames to be the same person, and determines these persons to be different people. Then, an ID “58” is newly assigned to the person indicated by the rectangular area 136. Also in such a case, it can be considered that the issue is solved by adding an image having an external appearance close to that of an image in a rectangle analogized based on a trajectory of the person tracking from the previous frame to training images.

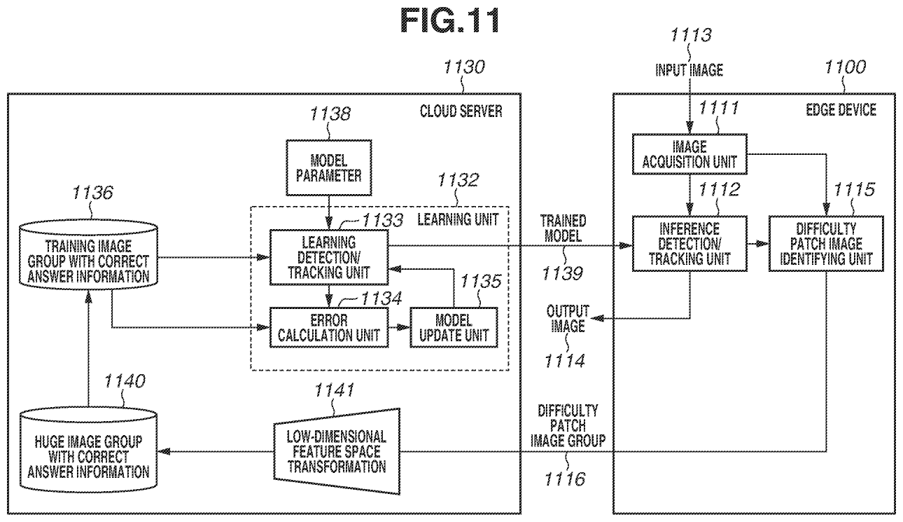

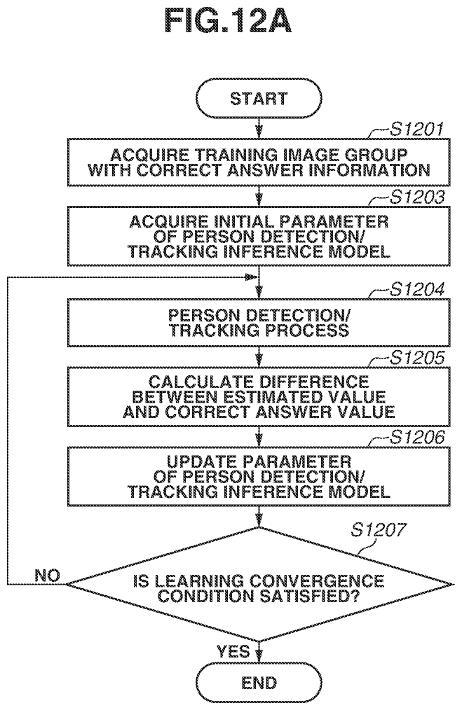

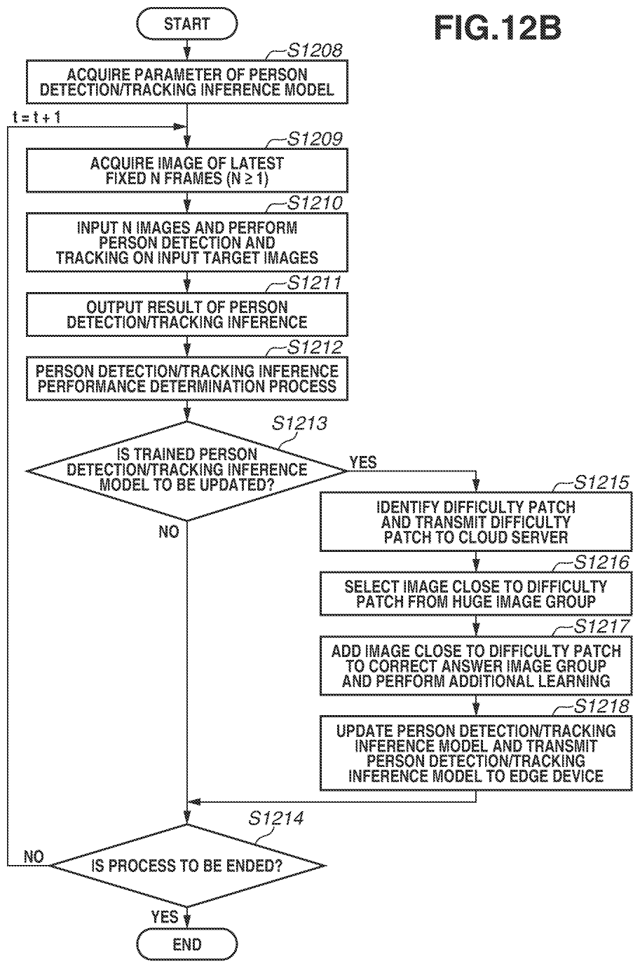

A description is given of examples of a configuration and processing for enhancing the performance of a CNN by adding an image patch appropriate for the test environment at a predetermined timing when a test is performed as exemplified above, with reference to FIGS. 11, 12A, and 12B.

### (Functional Configuration of Entirety of System)

With reference to FIG. 11, an example will now be described of a functional configuration of the information processing system according to the present exemplary embodiment. The information processing system according to the present exemplary embodiment includes an edge device 1100 and a cloud server 1130. The edge device 1100 includes an image acquisition unit 1111, an inference detection/tracking unit 1112, and a difficulty patch image identifying unit 1115. The cloud server 1130 includes a learning unit 1132. The learning unit 1132 includes a learning detection/tracking unit 1133, an error calculation unit 1134, and a model update unit 1135.

The configuration illustrated in FIG. 11 is merely an example, and can be appropriately modified or changed. For example, a single functional unit may be divided into a plurality of functional units, or two or more functional units may be integrated into a single functional unit. The configuration illustrated in FIG. 11 may be embodied as two or more apparatuses. In this case, the apparatuses may be connected to each other via a circuit or a wired or wireless network and cooperatively operate by communicating data with each other, performing processes according to the present exemplary embodiment.

First, the details of the functional units of the edge device 1100 will be described.

The image acquisition unit 1111 acquires input image data 1113 as a processing target. The input image data 1113 is a plurality of chronologically successive monitoring images.

The inference detection/tracking unit 1112 causes a trained model 1139 transmitted from the cloud server 1130 to perform inference detection on a person on each input image, and determines whether people detected by performing inference tracking are the same person in temporally adjacent frames. Then, the inference detection/tracking unit 1112 outputs to a predetermined output destination an output image 1114 to which a person ID is assigned and a detection rectangle is attached.

The difficulty patch image identifying unit 1115 determines whether the result of the estimation in the test environment by the inference detection/tracking unit 1112 using the trained model 1139 transmitted to the edge device 1100 is favorable. Then, based on the result of the determination, the difficulty patch image identifying unit 1115 identifies a difficulty patch in which the accuracy of the estimation performance of the trained model 1139 is less than or equal to a threshold.

Specifically, the difficulty patch image identifying unit 1115 receives an image input from the image acquisition unit 1111 and an image equivalent to the output image 1114 to which the person ID is assigned and the detection rectangle is attached by the inference detection/tracking unit 1112. Based on these images, the difficulty patch image identifying unit 1115 determines whether the person as the target is well detected and tracked in the test environment. Then, the difficulty patch image identifying unit 1115 determines a difficulty patch image group 1116 that causes the determination that the result of the estimation is not favorable (the estimation performance is less than or equal to the threshold) in the test environment as the result of the determination. Then, the difficulty patch image identifying unit 1115 transmits the difficulty patch image group 1116 to the cloud server 1130.

The difficulty patch image group 1116 is transformed into feature amounts in a learned low-dimensional feature space by low-dimensional feature space transformation 1141. Then, the difficulty patch image group 1116 transformed into the low-dimensional feature amounts is input as a query to a huge image group 1140.

Rectangle information in a form similar to that of a rectangular area generally taught in a person detection task as exemplified with reference to FIG. 13 is assigned to an image obtained by capturing a person held in the huge image group 1140. In a scene of relatively short successive images, rectangular areas corresponding to the same person in temporally adjacent frames are held by assigning the same ID to the rectangular areas. The huge image group 1140 may include an image of a scene where a person is not captured. Information indicating that the above rectangular area (i.e., an area corresponding to a person) is not included may be assigned to such an image.

The above query is a query used to search for a similar image patch to additionally learn an image patch close to a difficulty patch that has occurred in the test environment. Then, a learning scene including an image patch having a feature close to that of a difficulty patch image group is selected based on the query, and an image corresponding to the learning scene is added to a training image group 1136. The training image group 1136 is applied to the training of a model by the cloud server 1130 in the following description, providing a model more favorable in person detection/tracking performance in the test environment.

Next, the functional units of the cloud server 1130 will be described.

An image to be applied to learning is uploaded to the cloud server 1130. A data set of images to be applied to learning including this image is held as the training image group with correct answer information 1136 in the cloud server 1130. Each image of the training image group with correct answer information 1136 is composed of a relatively short scene, similarly to the form of an image held in the above huge image group 1140, and rectangle information indicating an area where a person is captured and ID information regarding an ID assigned to the person are attached to the image. It is desirable that the training image group with correct answer information 1136 sufficiently include data on images that satisfy conditions, such as a background, an angle of view, and a person size closer to those of the test environment.

The learning unit 1132 acquires a model parameter 1138 to be applied to a CNN in person detection/tracking learning, initializes the weight of the CNN using the model parameter 1138, and then trains the CNN.

The model parameter 1138 includes hyperparameters indicating the initial values of parameters of the neural network, the structure of the neural network, and the optimization method. The person detection/tracking learning in the learning unit 1132 is performed by the learning detection/tracking unit 1133, the error calculation unit 1134, and the model update unit 1135.

The CNN used by the learning unit 1132 is the same neural network as a CNN used by the inference detection/tracking unit 1112. The simplest configuration is based on the premise that two types of CNNs, namely a person detection CNN and a person tracking CNN, are used. The person detection CNN is a CNN that detects a person area based on a single frame input to the CNN. The person tracking CNN is a CNN to which detected person area rectangles are input in the chronological direction in a plurality of fixed frames and which determines the same person and assigns an ID to the same person.

On the other hand, the above processing may be performed by a single CNN. In this case, the learning detection/tracking unit 1133 and the inference detection/tracking unit 1112 may be implemented as a single functional block.

### (Procedure of Processing of Entirety of System)

With reference to FIGS. 12A and 12B, an example will be described of the processing of the information processing system according to the present exemplary embodiment. Each of FIGS. 12A and 12B is a flowchart illustrating an example of the procedure of the processing of the information processing system according to the present exemplary embodiment.

First, with reference to FIG. 12A, a description is given of an example of the procedure of a series of processes of person detection/tracking learning by the cloud server 1130.

In step S1201, the cloud server 1130 receives the inputs of the training image group 1136 to which rectangle information indicating an area of a person prepared in advance and an ID assigned to the person are assigned as correct answer information.

In step S1203, the cloud server 1130 receives the input of the model parameter 1138 to be applied to a CNN used in the person detection and tracking. As described above, the model parameter 1138 includes the initial values of parameters obtained by putting together the weight and the bias of the neural network that lead to an optimal result after the learning. The input model parameter 1138 is transmitted to the learning unit 1132.

In step S1204, the learning detection/tracking unit 1133 initializes the weight of the CNN using the received model parameter 1138 and then performs the person detection and tracking.

In step S1205, the error calculation unit 1134 calculates the difference between the result of the estimation of the person detection and tracking and the correct answer data (the training image group 1136 to which the correct answer information is assigned).

In step S1206, as described above, the model update unit 1135 updates the model parameter 1138 so that the difference calculated in step S1205 is smaller (or minimized).

In step S1207, the learning unit 1132 determines whether a learning convergence condition is satisfied.

The learning convergence condition is not particularly limited, and can be appropriately set according to the use case. As a specific example, whether the number of updates of the model parameter 1138 in the learning unit 1132 reaches a predetermined number of times may be set as the learning convergence condition.

If the learning unit 1132 determines in step S1207 that the learning convergence condition is not satisfied (No in step S1207), the processing returns to step S1204. In this case, in the processes of step S1204 and the subsequent steps, learning using another piece of training image data and another piece of correct answer image data is performed.

Then, if the learning unit 1132 determines in step S1207 that the learning convergence condition is satisfied (Yes in step S1207), the series of processes illustrated in FIG. 12A ends.

Next, with reference to FIG. 12B, a description is given of an example of the procedure of a person detection/tracking inference process by the edge device 1100.

In step S1208, the edge device 1100 acquires the trained model 1139 trained by the cloud server 1130.

In step S1209, the image acquisition unit 1111 selects input image data on N frames (N≥1) from the input image data 1113 as a target of the person detection/tracking inference process and generates pieces of input linked image data linked together in a channel direction.

In step S1210, the inference detection/tracking unit 1112 constructs a CNN similar to the CNN used in the learning by the learning unit 1132 and performs person detection and tracking on the input linked image data. At this time, the inference detection/tracking unit 1112 initializes the existing model parameter 1138 based on the updated model parameter 1138 received from the cloud server 1130. As described above, the inference detection/tracking unit 1112 inputs the input linked image data to the CNN to which the updated model parameter 1138 is applied, and performs person detection and tracking on the input image data by a method similar to the method performed by the learning unit 1132, obtaining output image data.

In step S1211, the edge device 1100 outputs the output image data obtained in step S1210 as the output image 1114 to a predetermined output destination. As a specific example, the edge device 1100 may output the output image 1114 to the display device 40 illustrated in FIG. 1, displaying the output image 1114 on the display device 40. As another example, the edge device 1100 may output the output image 1114 to the external storage device 30, saving the output image 1114 in the external storage device 30.

In step S1212, the difficulty patch image identifying unit 1115 determines whether the result of the person detection and tracking in step S1210 is favorable. The determination of whether the result of the person detection and tracking is favorable can be made by a method described as follows. Specifically, from when a person goes into the screen to when the person comes out of the screen, the event where the same ID is not updated continues so long as the person performs a normal action. On the other hand, a behavior that causes an event where a person as a target is not detected, for example, because a condition for a partial area of the screen differs from when the learning is performed is clearly unstable and can be easily distinguished.

As a specific example, in the example illustrated in FIG. 13A, during the period when the person as the target passes through the area 134, the person ceases to be detected, preventing the display of a detection frame indicating a rectangular area corresponding to the person. As a result, the detection frame disappears from the image. As described above, if a frame is detected in which an event occurs where is not conceivable in reality, such as the sudden disappearance of a person that should be present in the screen, it can be determined that person detection and tracking on the area of the person in the frame are not favorable.

In a general application, even if a detection frame of a person disappears, the person cannot suddenly disappear. Thus, the process of drawing the detection frame at a position predicted from the rectangle coordinates and the moving velocity of past several frames by rule-based processing is often applied.

Thus, regarding an area to be held as a difficulty patch when it is determined in step S1212 that the result of the person detection and tracking is not favorable, a person area that cannot be detected by the CNN may be determined to be an area image in a rectangle clipped by the rule-based processing exemplified above.

Alternatively, examples of a case where it can be determined that the result of the person detection and tracking is not favorable include a case where the external appearance of the same person rapidly changes as when a person is detected in the example illustrated in FIG. 13B, causing the person tracking CNN to determine the person to be a different person, and the ID to change. In this case, an event occurs that is impossible in a general monitoring scene, such as the sudden appearance of a person that has not been present in the previous frame in a partial area of the image. As described above, if a frame is detected in which an event occurs that is not conceivable in reality, such as the sudden appearance of a person that has not been present in the past in the screen, it can be determined that person detection and tracking on the area of the person in the frame are not favorable. In this case, it is also possible to hold an image of the person who suddenly appears in the screen and to whom a new ID is assigned as a difficulty patch image.

As described above, in step S1212, for example, the difficulty patch image identifying unit 1115 compares the result of the person detection and tracking in step S1210 with a threshold set in advance, determining whether the result of the person detection and tracking is favorable. Based on the result of the determination, the difficulty patch image identifying unit 1115 identifies and holds a difficulty patch. In other words, the difficulty patch image identifying unit 1115 compares the results of the person detection and tracking on frames with each other and identifies an image patch corresponding to a frame in which the tendency of the result of the person detection and tracking is different from that in another frame (e.g., the difference is greater than or equal to a threshold) as a difficulty patch and holds the difficulty patch.

In step S1213, the difficulty patch image identifying unit 1115 determines whether to update the trained person detection/tracking inference model 1139. Specifically, if a difficulty patch is held, the difficulty patch image identifying unit 1115 determines that it is necessary to update the trained person detection/tracking inference model 1139.

If the difficulty patch image identifying unit 1115 determines in step S1213 that the trained person detection/tracking inference model 1139 is to be updated (Yes in step S1213), the processing proceeds to step S1215.

If, on the other hand, the difficulty patch image identifying unit 1115 determines in step S1213 that the trained person detection/tracking inference model 1139 is not to be updated (No in step S1213), the processing proceeds to step S1214.

In step S1215, the difficulty patch image identifying unit 1115 transmits the held difficulty patch to the cloud server 1130.

In step S1216, the cloud server 1130 compares a vast number of image patches held in the huge image group 1140 and the difficulty patch transmitted in step S1215 and selects a patch image having a feature close to that of the difficulty patch from the huge image group 1140. The method for obtaining a low-dimensional distance feature space for selecting a close image is substantially similar to that in the first exemplary embodiment, and is not described in detail.

In step S1217, the cloud server 1130 adds the close-to-difficulty-patch image having a feature close to that of the difficulty patch and selected in step S1216 to the training image group with correct answer information 1136. Then, after adding the close-to-difficulty-patch image to the training image group with correct answer information 1136, the cloud server 1130 performs processing similar to that of the learning procedure described above. Then, if the learning converges, then in step S1218, the cloud server 1130 updates the inference person detection/tracking model 1139 and transmits the updated inference person detection/tracking model 1139 to the inference detection/tracking unit 1112 of the edge device 1100. By the above processing, the model 1139 of the inference detection/tracking unit 1112 is updated according to the tendency of an input image in the test environment. This leads to an expectation to enhance the accuracy of the person detection and tracking in the test environment.

In step S1214, the edge device 1100 determines whether to end the person detection/tracking inference process. The determination of whether to end the person detection/tracking inference process in step S1214 may be made, for example, based on whether an instruction to end the person detection/tracking inference process is received from the user through the input device 20.

If the edge device 1100 determines in step S1214 that the person detection/tracking inference process is not to be ended (No in step S1214), the processing returns to step S1209. In this case, the processes of step S1209 and the subsequent steps are performed again using the next frame as a target. As described above, the processes of step S1209 and the subsequent steps are repeatedly performed until it is determined in step S1214 that the person detection/tracking inference process is to be ended. Consequently, an area where the person detection/tracking performance is not favorable is determined at any time by the person detection/tracking inference performance determination process in step S1212, and additional learning continues to be performed each time, maintaining a person detection/tracking inference model tailored to a change in the test environment.

Then, if the edge device 1100 determines in step S1214 that the person detection/tracking inference process is to be ended (Yes in step S1214), the series of processes illustrated in FIG. 12B ends.

In the present exemplary embodiment, the description has been given of an example of a case where inference for detection and tracking is performed on a person as a target. The target of the inference, however, is not necessarily limited to a person. That is, also under a situation where detection and recognition are performed on another object other than a person as a detection target, a situation is conceivable where the detection and the recognition will fail. Thus, the additional learning described in the present exemplary embodiment allows enhancement (improvement) of the performance of the detection and the recognition.

Various descriptions have been given on the premise that AI that performs the inference according to the present exemplary embodiment is implemented by a model trained by deep learning or machine learning. The method for this AI, however, is not particularly limited so long as a similar purpose can be achieved.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-005394, which was filed on Jan. 17, 2023 and which is hereby incorporated by reference herein in its entirety.

What is claimed is:

1. An apparatus comprising:
at least one processor; and
a memory coupled to the at least one processor, the memory storing instructions that, when executed by the at least one processor, cause the at least one processor to:
identify a partial image corresponding to an area in an image in which performance of inference by a learning model that performs predetermined inference on an input image is less than or equal to a threshold;
collect a similar image similar to the identified partial image; and
based on additional images including the collected similar image, improve a result of the inference by the learning model targeted at a test environment different from a training environment of the learning model.

2. The apparatus according to claim 1, wherein in a training process of the learning model, the partial image in which the performance of the inference on the input image by the learning model is less than or equal to the threshold is identified.

3. The apparatus according to claim 1, wherein the additional images include the collected similar image and the identified partial image.

4. The apparatus according to claim 1, wherein in a low-dimensional distance space defined in advance, an image at a closer distance from the identified partial image is collected as the similar image similar to the partial image.

5. The apparatus according to claim 1,
wherein the learning model restores the input image, thereby outputting a restoration image as the result of the inference, and
wherein a cumulative average image of images of areas in still states in a plurality of images successive in a chronological direction and the restoration image output as the result of the inference by the learning model are compared with each other, thereby identifying the partial image in which the performance of the inference is less than or equal to the threshold.

6. The apparatus according to claim 1,
wherein the learning model detects a predetermined detection target in the input image and outputs a result of detecting the detection target as the result of the inference, and
wherein results of detecting the detection target from a plurality of images successive in a chronological direction are compared with each other, and a partial image according to a result of detecting the detection target from an image having a tendency different from a tendency of a result of detecting the detection target from another image is identified.

7. The apparatus according to claim 1, wherein the predetermined inference is learned by updating a parameter of the learning model using the additional images.

8. An apparatus comprising:
at least one processor; and
a memory coupled to the at least one processor, the memory storing instructions that, when executed by the at least one processor, cause the at least one processor to:
acquire a partial image identified based on a cumulative average image of a plurality of images and corresponding to an area in an image in which performance of inference by a learning model that performs predetermined inference on an input image is less than or equal to a threshold;
collect a similar image similar to the acquired partial image; and
by using additional images including the collected similar image, improve a result of the inference by the learning model targeted at a test environment different from a training environment of the learning model.

9. A method comprising:
identifying a partial image corresponding to an area in an image in which performance of inference by a learning model that performs predetermined inference on an input image is less than or equal to a threshold;
collecting a similar image similar to the identified partial image; and
by using additional images including the collected similar image, improving a result of the inference by the learning model targeted at a test environment different from a training environment of the learning model.

10. The method according to claim 9, wherein in a training process of the learning model, the partial image in which the performance of the inference on the input image by the learning model is less than or equal to the threshold is identified.

11. The method according to claim 9, wherein the additional images include the collected similar image and the identified partial image.

12. The method according to claim 9, wherein in a low-dimensional distance space defined in advance, an image at a closer distance from the identified partial image is collected as the similar image similar to the partial image.

13. The method according to claim 9,
wherein the learning model restores the input image, thereby outputting a restoration image as the result of the inference, and
wherein a cumulative average image of images of areas in still states in a plurality of images successive in a chronological direction and the restoration image output as the result of the inference by the learning model are compared with each other, thereby identifying the partial image in which the performance of the inference is less than or equal to the threshold.

14. The method according to claim 9,
wherein the learning model detects a predetermined detection target in the input image and outputs a result of detecting the detection target as the result of the inference, and
wherein results of detecting the detection target from a plurality of images successive in a chronological direction are compared with each other, and a partial image according to a result of detecting the detection target from an image having a tendency different from a tendency of a result of detecting the detection target from another image is identified.

15. The method according to claim 9, wherein the predetermined inference is learned by updating a parameter of the learning model using the additional images.

16. A method comprising:
acquiring a partial image identified based on a cumulative average image of a plurality of images and corresponding to an area in an image in which performance of inference by a learning model that performs predetermined inference on an input image is less than or equal to a threshold;
collecting a similar image similar to the acquired partial image; and
by using additional images including the collected similar image, improving a result of the inference by the learning model targeted at a test environment different from a training environment of the learning model.

17. A non-transitory computer-readable storage medium storing a program for causing a computer to execute a method comprising:
identifying a partial image corresponding to an area in an image in which performance of inference by a learning model that performs predetermined inference on an input image is less than or equal to a threshold;
collecting a similar image similar to the identified partial image; and
by using additional images including the collected similar image, improving a result of the inference by the learning model targeted at a test environment different from a training environment of the learning model.

18. The non-transitory computer-readable storage medium according to claim 17, wherein in a training process of the learning model, the partial image in which the performance of the inference on the input image by the learning model is less than or equal to the threshold is identified.

19. The non-transitory computer-readable storage medium according to claim 17, wherein the additional images include the collected similar image and the identified partial image.

20. The non-transitory computer-readable storage medium according to claim 17, wherein in a low-dimensional distance space defined in advance, an image at a closer distance from the identified partial image is collected as the similar image similar to the partial image.
